(19) United States
(12) Patent Application Publication
(10) Pub. No.: US 2026/0305536 A1
(43) Pub. Date: Oct. 8, 2026

(54) TRIMMING TOOL

(71) Applicant: Lawnix Technology (Nanjing) Co., Ltd., Nanjing (CN)

(72) Inventors: Baojian Yang, Nanjing (CN); Xiaoke Zou, Nanjing (CN)

(21) Appl. No.: 19/553,013

(22) Filed: Feb. 27, 2026

(30) Foreign Application Priority Data
Apr. 2, 2025 (CN) 202520618063.7
Dec. 31, 2025 (CN) 202512059010.3

(51) Int. Cl. A01G 3/053; A01G 3/04; F21V 33/00; F21W 111/00

(52) U.S. Cl. CPC A01G 3/053; F21V 33/008; A01G 2003/0461; F21W 2111/00

(57) ABSTRACT

Disclosed herein is a trimming tool, including: a housing, provided with a protective plate thereon; a cutting mechanism and a driving mechanism, both disposed on the housing, where the cutting mechanism has a cutting plane, and the driving mechanism is configured to drive the cutting mechanism to operate; and an indicating mechanism, disposed on the protective plate and configured to indicate a deflection state of the cutting plane relative to a reference plane, where the deflection state is a state in which the cutting plane is deflected relative to the reference plane about a deflection axis.

### CROSS-REFERENCE

The present disclosure claims priority to Chinese Patent Application No. 202520618063.7, filed Apr. 2, 2025, entitled “PRUNING MACHINE” and No. 202512059010.3, filed Dec. 31, 2025, entitled “PRUNING TOOL”. The entire disclosures of Chinese Patent Application Nos. 202520618063.7 and 202512059010.3 are incorporated herein by reference.

### TECHNICAL FIELD

Embodiments of the present disclosure relate to the technical field of trimming tools and, in particular, to a trimming tool.

### BACKGROUND

Currently, in the field of horticulture, trimming tools are widely used for trimming the branches and leaves of plants such as flowers, grass, trees, and shrubs, so as to control plant height and contour, maintain the neatness and aesthetic appeal of the overall landscape, and promote the healthy growth of the plants. When relevant trimming tools are used, the trimmed vegetation may not reach the desired uniform height, easily leading to inconsistent trimming heights and uneven cutting lines, consequently affecting the neatness and overall appearance of the trimming effect.

### SUMMARY

According to a first aspect of the embodiments of the present disclosure, a trimming tool is provided, including: a housing, provided with a protective plate thereon; a cutting mechanism, disposed on the housing and having a cutting plane; a driving mechanism, disposed on the housing and configured to drive the cutting mechanism to operate; and an indicating mechanism, disposed on the protective plate and configured to indicate a deflection state of the cutting plane relative to a reference plane, where the deflection state is a state in which the cutting plane is deflected relative to the reference plane about a deflection axis, and the deflection axis is a straight line extending along a length direction of the cutting plane and parallel to the reference plane.

According to a second aspect of the embodiments of the present disclosure a trimming tool is provided, including: a housing, provided with a protective plate thereon; a cutting mechanism, disposed on the housing and having a cutting plane; a detection mechanism, disposed on the housing and configured to detect a deflection state of the cutting plane relative to a reference plane and output a detection signal; a first lead wire, having one end electrically connected to the detection mechanism, the first lead wire being configured to transmit the detection signal acquired by the detection mechanism; a control mechanism, disposed on the housing, electrically connected to the other end of the first lead wire, and configured to output a display signal based on the detection signal; a driving mechanism, configured to drive the cutting mechanism to operate; an indicating mechanism, disposed on the housing; and a second lead wire, having one end electrically connected to the control mechanism and the other end connected to the indicating mechanism, the second lead wire being configured to transmit the display signal onto the indicating mechanism, where the indicating mechanism is configured to indicate the deflection state of the cutting plane relative to the reference plane based on the display signal.

According to a third aspect of the embodiments of the present disclosure, a trimming tool is provided, including: a housing, including a first housing provided with a first handle and a second housing provided with a second handle, the first housing being movable relative to the second housing between a first position and a second position; a cutting mechanism, disposed on the housing and having a cutting plane; an indicating mechanism, disposed on the housing and configured to indicate a deflection state of the cutting plane relative to a reference plane; and a control mechanism, disposed on the housing and configured to: when the first housing is in the first position relative to the second housing, control the indicating mechanism to indicate the deflection state of the cutting plane relative to the reference plane in a first preset area; and when the first housing is in the second position relative to the second housing, control the indicating mechanism to indicate the deflection state of the cutting plane relative to the reference plane in a second preset area.

### BRIEF DESCRIPTION OF THE DRAWINGS

The above and other features and advantages of the present disclosure will become more apparent by describing exemplary embodiments in detail with reference to the accompanying drawings.

FIG. 1 is a first schematic view of an overall structure of a trimming tool according to an embodiment of the present disclosure;

FIG. 2 is an enlarged view of portion A in FIG. 1;

FIG. 3 is a schematic view illustrating a first included angle formed between a display surface of an indicating mechanism and a cutting plane;

FIG. 4 is a schematic view illustrating a second included angle formed between a preset plane and the cutting plane;

FIG. 5 is a schematic view illustrating a third included angle formed between a plane defined by a line connecting a top end of a first handle and a top end of a protective plate and a horizontal plane where the top end of the first handle lies;

FIG. 6 is a schematic view illustrating a fourth included angle formed between a plane defined by a line connecting a vertex on a side portion of the first handle and a vertex on a side portion of the protective plate and the cutting plane;

FIG. 7 is a schematic view illustrating a widest distance of a projection of the first handle and a widest distance of a projection of the indicating mechanism;

FIG. 8 is a second schematic view of the overall structure of the trimming tool according to an embodiment of the present disclosure;

FIG. 9 is an enlarged view of portion B in FIG. 8;

FIG. 10 is a schematic structural view of the trimming tool according to an embodiment of the present disclosure; and

FIG. 11 is an enlarged view of portion C in FIG. 10.

Reference signs used in the figures:

1: housing; 11: protective plate; 111: first protective layer; 112: second protective layer; 12: first handle; 121: gripping portion; 13: second handle; 14: first housing; 15: second housing; 2: cutting mechanism; 3: driving mechanism; 31: driving motor; 32: driving seat; 4: indicating mechanism; 41: light panel; 411: light bead group; 5: detection mechanism; 6: first lead wire; 7: second lead wire; 71: third lead wire; 72: fourth lead wire; 8: control mechanism; 81: first control board; 82: second control board; 9: sensing mechanism; 10: debris shield; S0: cutting plane; S1: first reference plane; S2: second reference plane; S3: display surface; S4: preset plane; R1: first included angle; R2: second included angle; R3: third included angle; R4: fourth included angle; R5: included angle of inclination; L1: first distance; L2: second distance; DU1: first damping unit; DU2: second damping unit; DU3: third damping unit; DU4: fourth damping unit; and DU5: fifth damping unit.

### DETAILED DESCRIPTION

Exemplary embodiments will now be described in more detail with reference to the accompanying drawings. However, the exemplary embodiments can be embodied in many forms and should not be construed as limited to the embodiments set forth herein. Rather, these embodiments are provided so that the present disclosure will be thorough and complete, and will fully convey the concepts of the exemplary embodiments to those skilled in the art. The same reference signs in the accompanying drawings denote the same or similar structures, and thus their detailed descriptions will be omitted.

The features, structures, or characteristics described above may be combined in one or more embodiments in any suitable manner. Where possible, the features discussed in the various embodiments are interchangeable. In the above description, numerous specific details are provided to give a thorough understanding of the embodiments of the present disclosure. However, it will be recognized by those skilled in the art that the technical solutions of the present disclosure may be practiced without one or more of the specific details, or other methods, assemblies, or materials may be employed. In other circumstances, well-known structures, materials, or operations are not shown or described in detail to avoid obscuring various aspects of the present disclosure.

Although relative terms such as “upper” and “lower” are used in the present disclosure to describe the relative relationship of one assembly with respect to another assembly in the accompanying drawings, these terms are used herein merely for convenience, for example, based on the directions illustrated in the accompanying drawings. It should be understood that if an apparatus in the accompanying drawings is turned upside down, an assembly described as being “upper” would become the assembly being “lower”. Other relative terms such as “high”, “low”, “top”, “bottom”, “front”, “rear”, “left”, “right”, and the like also have similar meanings. When a structure is described as being “on” a different structure, it may mean that the structure is integrally formed on the different structure, or that the structure is “directly” disposed on the different structure, or that the structure is “indirectly” disposed on the different structure via another structure.

In the present disclosure, the terms “a”, “an”, “the”, “said”, and “at least one” are used to indicate the presence of one or more elements or components; the terms “comprise”, “include”, and “have” are used to denote an open-ended inclusive meaning and refer to the possibility of additional elements or components existing besides the listed elements or components.

In some cases, when using a trimming tool, a user typically holds the handles of the trimming tool with both hands, positioning the cutting plane approximately at the desired trimming height or trimming trajectory. Then, the driving mechanism is activated to drive the blade in high-speed motion, and the trimming tool is moved slowly along the top or sides of hedges or shrubs to complete continuous trimming operations. During this process, the user mainly relies on visual observation of the position of the blade relative to the ground, fence, or plant tops, or combines personal experience to control the posture and movement trajectory of the trimming tool.

However, in practical operation, the cutting plane of the blade of the trimming tool is prone to deflection due to factors such as changes in the user's grip posture, wrist rotation, uneven terrain, and operational fatigue. When the cutting plane deflects, the user often needs to adjust his/her posture (for example, by lowering his/her head, turning his/her body, or stepping back) and repeatedly observe the position of the blade relative to the object being trimmed from different perspectives to determine whether the current trimming is maintained at the desired level or reference direction. This method makes it difficult for the user to promptly and continuously focus on the actual cutting condition ahead of the blade. Moreover, under working conditions requiring precise horizontal trimming (such as trimming the tops of hedges or shrubs), it is more likely to result in inconsistent trimming heights and uneven cutting lines, thereby affecting the neatness and overall appearance of the trimming effect.

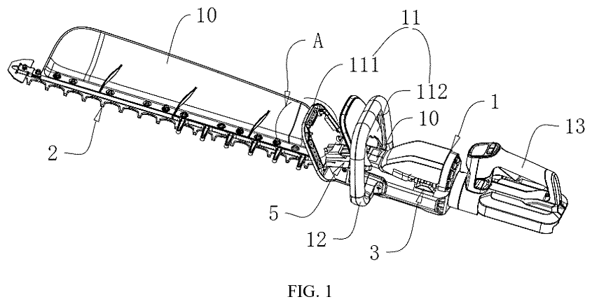

In view of the foregoing, reference may be made to FIGS. 1, 2, and 3, which illustrate a trimming tool including a housing 1, a cutting mechanism 2, a driving mechanism 3, and an indicating mechanism 4, where the housing 1 is provided with a protective plate 11 thereon; both the cutting mechanism 2 and the driving mechanism 3 are disposed on the housing 1, the cutting mechanism 2 has a cutting plane S0, and the driving mechanism 3 is configured to drive the cutting mechanism 2 to operate; and the indicating mechanism 4 is disposed on the protective plate 11 and is configured to indicate a deflection state of the cutting plane S0 relative to a reference plane, where a straight line extending along a length direction of the cutting plane S0 and parallel to the reference plane serves as a deflection axis, and the deflection state refers to a state in which the cutting plane S0 is deflected relative to the reference plane about the deflection axis.

The trimming tool includes, but is not limited to, pruning shears, grass trimmers, and other tools with cutting functions, where the pruning shears include, but are not limited to, those performing reciprocating motion along a length direction of the tool, as well as those performing reciprocating motion along a width direction of the tool.

The cutting plane S0 is a cutting motion plane formed when the cutting mechanism 2 performs a cutting action.

In some cases, the cutting plane S0 refers to a cutting motion plane defined by the movement of a cutting edge of the cutting mechanism during the cutting action, that is, the working plane that generates a cutting effect on target branches during the trimming process. In some embodiments, the cutting mechanism typically has oppositely arranged first and second side surfaces (e.g., upper and lower blade surfaces). The cutting plane S0 refers to a geometric plane formed by the cutting edge on an object being cut during actual cutting, rather than any structural surface of the cutting mechanism body.

In this embodiment, the protective plate 11 is disposed on the housing 1, located on a side of the cutting mechanism 2 proximate to an operator, and at least partially positioned between the cutting plane S0 and the operator. During the operation of the cutting mechanism 2, the protective plate 11 is used to block debris, dust, and foreign objects thrown out by the cutting mechanism 2, thereby reducing the likelihood of such objects directly flying toward the operator or the tool, thus providing a safety function. The indicating mechanism 4 is installed on the protective plate 11, establishing a definitive relative positional relationship between the indicating mechanism 4 and the cutting plane S0. When the cutting plane S0 is deflected relative to the reference plane about the deflection axis, the indicating mechanism 4 can provide an intuitive indication of the deflection state based on a pre-calibrated geometric relationship. After being arranged on the protective plate 11, the indicating mechanism 4 falls within the operator's normal field of vision. The operator can directly observe the indication results while holding the trimming tool in the normal manner, without needing to significantly change the operating posture, facilitating timely and accurate adjustments to the posture of the trimming tool.

Through the above structural configuration, on the one hand, the protective plate 11 not only provides physical protection for the operator but also serves as a mounting carrier for the indicating mechanism 4, integrating the protective function and the status indication function into one unit. This reduces the need for additional brackets or exposed components, making the structure more compact. On the other hand, by taking a straight line extending along the length direction of the cutting plane S0 and parallel to the reference plane as the deflection axis, the deflection of the cutting plane S0 relative to the reference plane is limited to a single-degree-of-freedom deflection about this deflection axis, facilitating detection, calibration, and display via the indicating mechanism 4. Thus, the trimming tool in this embodiment can provide real-time, intuitive feedback on the deflection state of the cutting plane S0 to the operator while ensuring operational safety, enabling the operator to make corrective adjustments to the trimming tool based on the indication.

In some embodiments, when the indicating mechanism 4 is installed on the protective plate 11, the protective plate 11 may employ different structural forms to adapt to various installation methods and protective requirements. The protective plate 11 may be a single-layer structure or a double-layer structure.

In some embodiments, the protective plate 11 is a single-layer structure, and the single-layer protective plate 11 may be integrally formed from a metal sheet or engineering plastic sheet, with a mounting surface for mounting the indicating mechanism 4 formed on a side facing the operator. The indicating mechanism 4 may be directly fixed onto the mounting surface by means such as screw connection, snap-fit connection, or adhesion. The lead wires connected to the indicating mechanism 4 are routed through wire holes formed in the protective plate 11 or directly led from the indicating mechanism 4 to the interior of the housing 1. The single-layer protective plate 11 features a simple structure, low manufacturing cost, and easy processing and assembly, making it suitable for situations where the mounting space for the indicating mechanism 4 is relatively limited.

In other embodiments, the protective plate 11 is a double-layer structure. The double-layer protective plate 11 includes a first protective layer 111 and a second protective layer 112 disposed sequentially along a front-to-rear direction of the trimming tool, where the first protective layer 111 faces the cutting mechanism 2, the second protective layer 112 faces the operator, and the first protective layer 111 and the second protective layer 112 are spaced apart, forming an accommodating space therebetween for accommodating the indicating mechanism 4. The indicating mechanism 4 is at least partially disposed inside the accommodating space, and a display surface S3 of the indicating mechanism 4 communicates with the outside through a window penetrating the second protective layer 112, facilitating observation by the operator; alternatively, the display surface S3 of the indicating mechanism 4 communicates with the outside through a window between the first protective layer 111 and the second protective layer 112, facilitating observation by the operator; and electrical connection leads of the indicating mechanism 4 are wired inside the accommodating space and extend out of the double-layer protective plate to the interior of the housing 1. The double-layer protective plate 11, on the one hand, reserves a mounting space for the indicating mechanism 4 without significantly increasing the overall outline dimensions of the trimming tool; on the other hand, it uses the first protective layer 111 to block debris splashed during the cutting process and utilizes the double-layer structure to enclose and protect the indicating mechanism 4 and leads thereof, thereby enhancing the protective performance and installation stability of the indicating mechanism 4.

It should be noted that the driving mechanism 3 and the cutting mechanism 2 may employ various existing structural forms well known to those skilled in the art, such as a cutting assembly composed of a motor, a transmission assembly, and a cutting blade, or a cutting assembly driven by an internal combustion engine, which do not limit this embodiment and therefore will not be elaborated in further detail.

For example, when using the trimming tool, the user holds the housing with both hands, positioning the protective plate and the indicating mechanism provided thereon toward a to-be-trimmed target. Driven by the driving mechanism, the cutting mechanism operates and forms a cutting plane for trimming. While trimming, the user moves the trimming tool along the tops or sides of hedges or shrubs, aligning the cutting plane approximately with the desired reference plane. When the posture of the trimming tool changes due to factors such as wrist rotation or changes in grip posture, the cutting plane deflects relative to the reference plane about a deflection axis extending along its length direction and parallel to the reference plane. The indicating mechanism on the protective plate indicates the deflection state of the cutting plane, thereby providing real-time, visual posture feedback within the user's forward field of view. Without frequently changing his/her posture (such as lowering his/her head, turning his/her body, or stepping back) or relying solely on experience for judgment, the user can directly understand the angle of inclination of the current cutting plane relative to the reference plane by observing the state of the indicating mechanism.

By arranging the indicating mechanism at the position of the protective plate and defining the deflection axis as a straight line extending along the length direction of the cutting plane and parallel to the reference plane, a unified geometric definition and an intuitive indication of the deflection state of the cutting plane relative to the reference plane are achieved. While facing a to-be-trimmed object, the user can continuously observe the direction and degree of deflection of the blade within his/her forward field of view. Through real-time posture feedback, the user can immediately and precisely adjust his/her grip posture and the posture of the trimming tool, ensuring that the cutting plane remains as close as possible to the desired reference plane (e.g., a horizontal plane). The user does not need to frequently lower his/her head or look back at the rear portion of the tool, thereby reducing the frequency of visual shifts and body position adjustments. This greatly minimizes unintended deflections caused by wrist rotation, posture changes, terrain influences, or fatigue. For the operator, the indicating mechanism provides an objective auxiliary reference, making it easier to master the technique of maintaining level trimming, lowering the learning curve, and reducing the time required for repeatedly confirming and adjusting the posture of the cutting plane. The user can perform trimming operations more smoothly and continuously, without needing to stop for adjustments or rework upon discovering uneven trimming. This helps maintain the cutting plane close to the predetermined reference plane, improves consistency in trimming height and cutting lines, and enhances the neatness and visual appearance of the trimming effect.

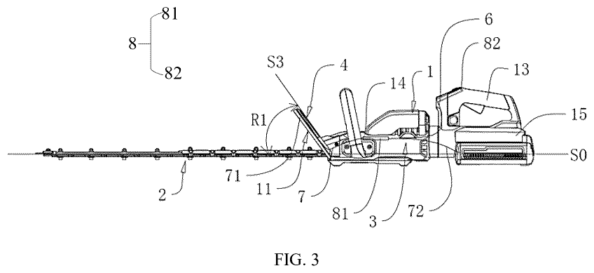

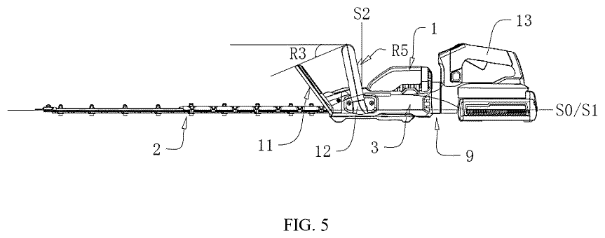

In some embodiments of the present disclosure, referring to FIGS. 1 and 3, the trimming tool is further provided with a detection mechanism 5 (disposed inside the housing 1) and a control mechanism 8, where the detection mechanism 5 is electrically connected to the indicating mechanism 4 and is configured to detect the deflection state of the cutting plane S0 relative to the reference plane and output a detection signal; the control mechanism 8 is configured to control an operating state of the indicating mechanism 4 based on the detection signal; and the reference plane includes a first reference plane S1 and/or a second reference plane S2 (see FIG. 5), where the first reference plane S1 is a plane in which the cutting plane S0 lies when the cutting plane S0 is parallel to the horizontal plane, and the second reference plane S2 is a plane in which the cutting plane S0 lies when the cutting plane S0 is perpendicular to the horizontal plane. In this way, the detection mechanism 5 can monitor the deflection state of the cutting plane S0 relative to the reference plane in real time (which may include, for example, precise angle and direction of deflection). This information is controlled by the control mechanism 8 to be directly presented via the indicating mechanism 4 within the operator's field of view, assisting the operator in promptly adjusting the posture of the trimming tool and ensuring the accuracy of the cutting operation.

In some exemplary embodiments, the detection mechanism 5 is not limited to a gyroscope or a level gage, such as a microelectromechanical system (MEMS) gyroscope. The gyroscope is installed at a position having a definite geometric relationship with the cutting plane S0 and is configured to sense a posture change of the trimming tool in space and output a detection signal corresponding to the posture change.

In this embodiment, during the operation of the trimming tool, the detection mechanism is electrically connected to the indicating mechanism to acquire the deflection state of the cutting plane relative to the reference plane in real time, and outputs a corresponding detection signal and transmits it to the control mechanism. Upon receiving the detection signal, the control mechanism adjusts the operating state of the indicating mechanism based on the deflection state, causing the indicating mechanism to reflect the current deflection condition. Thus, without changing the basic structure or operation method of the tool, the deflection detection results are intuitively output to the user.

By introducing the detection mechanism and the control mechanism, the detection mechanism can detect the angle of deflection of the cutting plane relative to a user-set reference plane in real time and automatically. The detection signal is transmitted to the control mechanism, which then drives the indicating mechanism to operate, providing intuitive feedback on the current deflection state. The control mechanism controls the operating state of the indicating mechanism based on the detection signal, which helps reduce reliance on user experience and subjective judgment and minimizes operational errors. The detection mechanism, the control mechanism, and the indicating mechanism form a closed-loop system. The detection signal is processed quickly and converted into an indication state with low feedback delay. Under working conditions requiring precise horizontal or vertical trimming, the user can more conveniently control the cutting plane within a posture range close to the target reference plane, thereby improving consistency in trimming height and cutting lines and enhancing the neatness and visual appearance of the overall trimming effect.

In some embodiments of the present disclosure, based on the foregoing solution, the reference plane includes a first reference plane and/or a second reference plane, where the first reference plane is a plane in which the cutting plane lies when the cutting plane is parallel to the horizontal plane, and the second reference plane is a plane in which the cutting plane lies when the cutting plane is perpendicular to the horizontal plane.

In this embodiment, the reference plane is explicitly defined as the plane in which the cutting plane lies when the cutting plane is parallel to or perpendicular to the horizontal plane, providing a clear and unified geometric reference for determining the deflection of the cutting plane. By defining the first reference plane (the plane when the cutting plane is horizontal) and the second reference plane (the plane when the cutting plane is vertical), the indicating mechanism can serve the two most common and precision-demanding trimming scenarios, meeting the diverse needs for reference directions in different trimming scenarios and enhancing the versatility and practicality of the tool.

In some embodiments of the present disclosure, the indicating mechanism 4 includes a set of light panels 41, where the light panels 41 are disposed on the protective plate 11.

In this embodiment, the user moves the trimming tool along positions such as the tops of hedges or shrubs. When the cutting plane deflects relative to the reference plane due to wrist rotation, changes in grip posture, or uneven terrain, the detection signal output by the detection mechanism is processed by the control mechanism, causing the display state of the light panels to change accordingly. While facing a to-be-trimmed object, the user can directly observe the changes in the light panels on the protective plate, thereby obtaining real-time information about the current deflection of the cutting plane. Based on the display state of the light panels, the user can adjust the posture of the trimming tool to realign the cutting plane with the target reference plane.

By arranging the light panels on the protective plate and within the same forward field of view as the cutting mechanism, compared to indication solutions that require looking down or back at a rear position, this solution enables the user to simultaneously observe the deflection state between the cutting plane and the reference plane during the trimming process without shifting his/her line of sight. By changing the display state of the light panels when deflection occurs, the deflection information, which originally relied on visual estimation and user experience, is converted into intuitive visual cues. This facilitates timely correction of the trimming tool's posture by the user, reducing inconsistencies in trimming height and uneven cutting lines, thereby improving the accuracy and consistency of trimming operations while lowering the operational burden.

As an example, the light panels 41 are disposed on the protective plate 11 within the operator's visible range. The light panels 41 have a definitive relative positional relationship with the cutting plane S0 and are configured to indicate the deflection state of the cutting plane S0 relative to the reference plane through the display state of the light panels 41. For example, the panel surface of the light panels 41 may be substantially arranged at an angle or parallel to the cutting plane S0, with the light panels 41 oriented toward the operator. When the deflection state of the cutting plane S0 relative to the reference plane changes, the control mechanism 8 can change the display pattern and/or display area of the light panels 41, thereby intuitively reflecting the direction and degree of deflection of the cutting plane S0. This makes it easier for the operator to adjust the posture of the trimming tool while observing the display of the light panels 41.

In some embodiments of the present disclosure, the indicating mechanism 4 includes at least one set of light panels 41. As an example, the indicating mechanism includes at least two sets of light panels 41, where the at least two sets of light panels 41 are disposed on the protective plate 11, and a predetermined angle is formed between projections of any two sets of light panels 41 on a plane of the protective plate 11.

In this embodiment, the indicating mechanism includes at least two sets of light panels separately installed on the protective plate, with a predetermined angle formed between projections of different light panels on the plane of the protective plate. During trimming, the user holds the trimming tool with both hands, and the protective plate along with the multiple sets of light panels thereon are located within the field of view in front of the cutting plane. After the detection mechanism outputs the deflection state of the cutting plane relative to the reference plane to the control mechanism, the control mechanism can control a corresponding set or portion of the light panels in different directions of deflection or posture ranges to change their display accordingly, thereby enabling the deflection states in different directions or ranges to be distinguished and indicated in different areas of the light panels on the protective plate. By observing which specific set of light panels changes, the user can determine the direction in which the cutting plane is deflected and within which deflection range, and make targeted adjustments to the left-right swing of the trimming tool accordingly.

With such a configuration, on the one hand, by arranging at least two sets of light panels on the protective plate at predetermined angles, each set of light panels corresponds to different indication directions or indication areas in their planar projections. This achieves “zonal display” of deflection information in space, making it easier for the user to intuitively distinguish the direction and approximate degree of deflection. On the other hand, by controlling only the display changes of some light panels or light panels in some areas, rather than uniformly changing the state of all light panels, more precise posture cues can be provided without increasing structural complexity. This enables the user to quickly identify which side the current cutting plane deflects toward and whether it has exceeded the expected range while maintaining forward vision, thereby improving the accuracy and responsiveness of trimming posture adjustments and further enhancing the straightness of trimming lines and the consistency of the overall trimming effect.

In some embodiments of the present disclosure, the indicating mechanism 4 may include at least two sets of light panels 41, where the at least two sets of light panels 41 are all disposed on the protective plate 11, and a predetermined angle is formed between projections of any two sets of light panels 41 on the plane of the protective plate 11. As an example, the indicating mechanism 4 may include at least three sets of light panels 41, where the at least three sets of light panels 41 are all disposed on the protective plate 11, and a predetermined angle is formed between projections of any two sets of light panels 41 on the plane of the protective plate 11.

In this embodiment, the projections of the light panels on the plane of the protective plate are parallel to each other, and the multiple sets of light panels form several indication strips extending in the same direction within the user's field of view. When the cutting plane deflects relative to the reference plane, the detection signal output by the detection mechanism is processed by the control mechanism, causing differences in the operating states among different light panels. For example, only one set or a portion of the light panels may change their display state, or different light panels may exhibit different operational responses under different deflection ranges. While facing a to-be-trimmed object, the user can directly observe the corresponding relationships of these parallel-distributed light panels along their length or width direction. Based on which set of light panels changes and the extent of the change, the user can determine the direction and approximate degree of the current cutting plane's deviation from the reference plane, thereby adjusting the posture of the trimming tool.

With such a configuration, on the one hand, arranging the multiple sets of parallel-distributed light panels are equivalent to arranging several parallel “reference lines” at the front end of the tool, enabling continuous indication of the cutting plane's deflection in a single direction, and even if the user's viewing angle slightly changes, the parallel geometric relationship among the light panels remains stable, which helps improve the readability and consistency of the indication information; on the other hand, by introducing differentiated operational responses among the mutually parallel light panels, different deflection ranges or degrees of deflection can be mapped onto different light panels or combinations thereof, which achieves graded display of deflection information in the same direction, making it easier for the user to determine whether the deflection exceeds an allowable range and to make posture corrections in a timely manner. This contributes to improving the straightness of trimming height and cutting lines, as well as enhancing the neatness and visual appearance of the trimming effect.

As an example, one set of light panels 41 may be arranged with their panel surfaces substantially oriented in a horizontal direction to serve as horizontal light panels 41; another set of light panels 41 may be arranged with their panel surfaces substantially oriented in a vertical direction to serve as vertical light panels 41. The vertical light panels 41 may be positioned to the left or right side of the horizontal light panels 41, forming an angle between projections of the horizontal light panels 41 and the vertical light panels 41 on the plane of the protective plate 11. Through such a configuration, the horizontal light panels 41 can be used to indicate the overall horizontal posture of the cutting plane S0 relative to the reference plane, while the vertical light panels 41 can be used to emphasize the deflection trend on a specific side. When a richer indication effect is required, another set of vertical light panels 41 may be reserved or added on a side opposite to the existing vertical light panels 41, forming a layout of at least three sets of light panels 41. This considers both structural simplicity and functional expansion without altering the predetermined angle design.

In this embodiment, with the series connection structure, where the output terminal of one light panel is electrically connected to the input terminal of the adjacent light panel in sequence, on the one hand, the multiple sets of light panels achieve signal transmission and control through cascading, eliminating the need for separate control lines for each set of light panels, which helps reduce the number of wiring harnesses and the occupation of control ports, simplifies the electrical connection structure, and lowers the complexity of wiring and assembly difficulty, thereby contributing to a reduction in overall manufacturing costs; on the other hand, the series connection facilitates the addition or reduction of light panels as needed. When expanding the indication area or improving deflection display resolution is required, it is only necessary to add light panel modules within the series chain, demonstrating good scalability. Furthermore, as the display signal is transmitted and responded to sequentially along the series path of the light panels, the user can quickly determine the current deflection state based on the number or distribution of illuminated light panels. This enables more precise and efficient adjustment of the trimming posture, enhancing the consistency and accuracy of the trimming effect.

As another example, one set of light panels 41 may be arranged with their panel surfaces substantially oriented in the horizontal direction, while the other two sets of light panels 41 are arranged with their panel surfaces substantially oriented in the vertical direction and are disposed on the left and right sides of the horizontal light panels 41, respectively, thereby forming a first predetermined angle (e.g., approximately 90°) between projections of any vertical light panel 41 and any horizontal light panel 41 on the plane of the protective plate 11, and forming a second predetermined angle (e.g., approximately 90°) between projections of the two sets of vertical light panels 41 on the plane of the protective plate 11. In this embodiment, the horizontal light panels 41 can indicate whether the cutting plane S0 is within a target horizontal neutral range relative to the reference plane; and the vertical light panels 41 on the left and right sides can respectively indicate the position and degree of deflection of the cutting plane S0 toward the left or right side, thereby providing an intuitive distinction for the direction and amount of deflection.

Furthermore, in this embodiment, the horizontal light panels 41 can also indicate whether the cutting plane S0 is within a target neutral range relative to the reference plane, as well as the position and degree of deflection toward the left or right side; and the left and right light panels can also indicate whether another reference plane is within a target horizontal neutral range and the position and degree of deflection toward the left or right side.

Specifically, in this embodiment, the horizontal light panels 41 disposed in the middle portion of the protective plate 11 can be used to indicate whether the cutting plane S0 is within a target horizontal neutral range relative to the first reference plane S1. Through the combination of illumination, positional distribution, and/or brightness variation of the light bead groups 411 on the light panels 41, they can indicate the position and degree of deflection of the cutting plane S0 toward the left or right side. The horizontal light panels 41 disposed in the middle portion of the protective plate 11 can also be used simultaneously to indicate whether the cutting plane S0 is within a target horizontal neutral range relative to both the first reference plane S1 and the second reference plane S2. Through the combination of illumination, positional distribution, and/or brightness variation of the light bead groups 411 on the horizontal light panels 41, they can indicate the neutral position of the cutting plane S0, as well as the direction and degree of deflection toward the left or right side.

The light panels 41 disposed on the left and right sides of the horizontal light panels 41 may correspond to the left side of the second reference plane S2 and the right side of the second reference plane S2, respectively. They are used to indicate whether the direction of the cutting plane S0 relative to their respective corresponding reference planes is within a horizontal neutral range of a target reference plane, as well as the position and angle of deflection toward the left or right side. On the same light panel 41, the greater the distance of the illuminated light bead groups 411 from the central reference position of that light panel and/or the higher their brightness, the larger the angle of deflection of the corresponding cutting plane S0 relative to the respective reference plane (the first reference plane S1 or the second reference plane S2).

For example, in one exemplary configuration, the light panel 41 on the left side of the protective plate 11 can be used to indicate the deflection state of the cutting plane S0 deflecting leftward relative to the second reference plane S2, and the light panel 41 on the right side of the protective plate 11 can be used to indicate the deflection state of the cutting plane S0 deflecting rightward relative to the second reference plane S2: when the cutting plane S0 deflects leftward relative to the second reference plane S2, the light bead group 411 on the left side of the left light panel 41 is illuminated or illuminated with higher brightness; when the cutting plane S0 returns to the horizontal neutral range of a target reference plane near the second reference plane S2, the light bead group 411 in the middle portion of the left light panel 41 remains constantly illuminated or displays a predetermined color; and when the cutting plane S0 deflects relative to the right side direction of the second reference plane S2, indication is provided through the light bead groups 411 at different positions, with different brightness, and/or different colors on the right light panel 41. Certainly, in another example, the left light panel 41 can be configured to display the deflection state of the cutting plane S0 relative to the second reference plane S2, and the right light panel 41 can be configured to display the deflection state of the cutting plane S0 relative to the first reference plane S1. The deflection information corresponding to the first reference plane S1 and the second reference plane S2 is distinguished by differences in the color, brightness, and/or flashing patterns of the light bead groups 411 to adapt to different product designs and user habits.

In another example, the right light panel 41 can be configured to display the deflection state of the cutting plane S0 relative to the second reference plane S2, and the left light panel 41 can be configured to display the deflection state of the cutting plane S0 relative to the first reference plane S1. The deflection information corresponding to the first reference plane S1 and the second reference plane S2 is distinguished by differences in the color, brightness, and/or flashing patterns of the light bead groups 411 to adapt to different product designs and user habits. Certainly, in another example, the horizontal light panel 41 disposed in the middle portion of the protective plate 11 can also be used simultaneously to indicate whether the cutting plane S0 is within the target horizontal neutral range relative to both the first reference plane S1 and the second reference plane S2. When the cutting plane S0 is within the neutral range relative to the first reference plane S1, the middle light beads 411 of the horizontal light panel 41 are illuminated with higher brightness. When the cutting plane S0 deflects leftward relative to the direction of the first reference plane S1, the light bead group 411 on the left side of the middle portion of the horizontal light panel 41 is illuminated or illuminated with higher brightness. When the cutting plane S0 deflects rightward relative to the direction of the first reference plane S1, the light bead group 411 on the right side of the middle portion of the horizontal light panel 41 is illuminated or illuminated with higher brightness. When the cutting plane S0 is within the horizontal neutral range of the target reference plane near the second reference plane S2, the light bead group 411 on the relatively left side of the middle portion of the horizontal light panel 41 remains constantly illuminated or displays a predetermined color. At this time, the relatively left light beads serve as display light beads for the horizontal neutral range. These display light beads serve as a reference, with light beads on the left and right sides capable of indicating leftward or rightward deflection of the cutting plane S0 relative to the left side direction of the second reference plane. When the cutting plane S0 deflects rightward relative to the second reference plane S2, the light bead group 411 on the relatively right side of the middle portion of the horizontal light panel 41 remains constantly illuminated or displays a predetermined color. At this time, the relatively right light beads serve as display light beads for the neutral range. These display light beads serve as a reference, with corresponding light beads on the left and right sides capable of indicating leftward or rightward deflection of the cutting plane S0 relative to the right side direction of the second reference plane.

As another example, two sets of light panels 41 are arranged with their panel surfaces on the left and right sides of the protective plate 11, respectively, and are symmetrically inclined relative to the vertical direction. This causes projections of the two sets of light panels 41 on the plane of the protective plate 11 to form an angled relationship resembling an inverted “V” shape. That is to say, the projections of the two sets of light panels 41 diverge upward or downward from each other on the plane of the protective plate 11, forming a third predetermined angle. The beneficial effect of this inverted “V” shape is as follows: on the one hand, the inclined light panels 41 on both sides can visually create a natural convergent or divergent guidance, making it easier for the operator to distinguish the direction and degree of deflection; on the other hand, compared to a completely vertical arrangement, the inclined arrangement can optimize the viewing angle based on the grip posture, reduce visual deflection, and improve comfort during prolonged operation.

It should be noted that, in addition to the inverted “V” shape described above, the combined shapes of the light panels 41 may also be “V” shaped, inverted “V” shaped, “U” shaped, “gate” shaped, or in other polygonal or curved configurations. As long as a predetermined angle is formed between projections, such as geometric projections, of different light panels 41 on the plane of the protective plate 11 and an intuitive indication of the deflection state of the cutting plane S0 can be achieved, the specific configuration can be selected and designed according to practical needs, and the present disclosure is not limited to the aforementioned specific forms.

Further, it should be noted that in the present disclosure, directional terms such as left and right are determined based on the user's operational state: when the user normally holds the handles of the trimming tool and performs trimming operations with the cutting plane S0 facing forward, the left side of the trimming tool corresponds to the left hand side of the user, and the right side corresponds to the right hand side of the user. These directional terms are used solely for the convenience of explaining the relative positional relationships among the components and do not limit the scope of protection of the present disclosure.

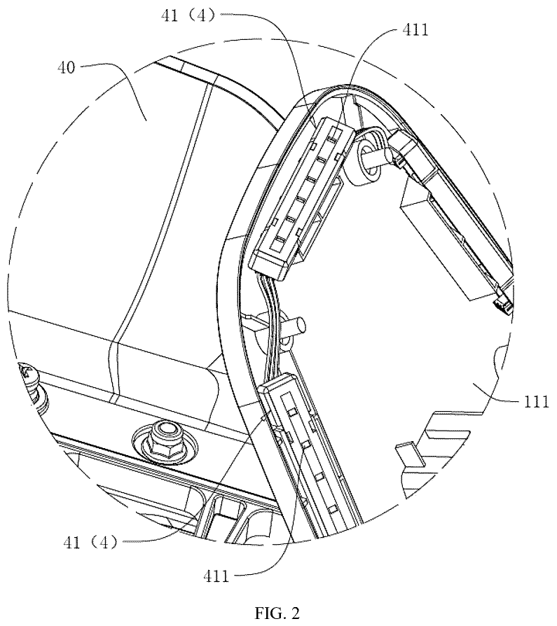

In some embodiments of the present disclosure, referring to FIG. 2, the indicating mechanism 4 includes at least two sets of light panels 41, where the at least two sets of light panels 41 are disposed on the protective plate 11, and projections of the at least two sets of light panels 41 on the plane of the protective plate 11 are parallel to each other. By arranging the at least two sets of light panels 41 on the protective plate 11 with their projections parallel to each other on the plane of the protective plate 11, on the one hand, the light panels 41 are aligned along the same reference direction, unifying the reading direction of the indication information, and the operator only needs to observe changes among different light panels 41 or within different display areas of the same light panel 41 along a single direction to determine the deflection of the cutting plane S0 relative to the reference plane, thereby reducing the visual recognition burden and enhances the intuitiveness and readability of the indication information; on the other hand, the parallel arrangement of the two sets of light panels 41 makes the overall layout of the indicating mechanism 4 on the protective plate 11 more regular and orderly, which facilitates unified wiring planning, makes it easier to add or remove light panels 41 for functional expansion, and reduces mutual obstruction between the light panels 41, thereby improving the compactness and aesthetic appeal of the structural layout and balancing manufacturing and assembly convenience with product appearance consistency while ensuring the indicating functionality.

In some embodiments of the present disclosure, the indicating mechanism 4 includes at least two sets of light panels 41, where among two adjacent sets of the light panels 41, an output terminal of one set of the light panels 41 is electrically connected to an input terminal of another set of the light panels 41 in sequence. By electrically connecting the output terminal of one set of light panels 41 to the input terminal of another set of light panels 41 in sequence among two adjacent sets of the light panels 41, a series or cascade relationship is formed, and the multiple sets of light panels 41 can be driven sequentially by the same control channel, reducing the number of independent connections between the light panels 41 and the control mechanism 8, as well as the number of control ports, thereby lowering the complexity of circuit wiring and the cost of the control circuit.

In some embodiments of the present disclosure, referring to FIGS. 1 and 3, the housing 1 is provided with a first handle 12 and a second handle 13, where the first handle 12 is disposed at one end of the housing 1 proximate to the cutting mechanism 2 and the protective plate 11, the second handle 13 is disposed at the other end of the housing 1 distal from the cutting mechanism 2 and the protective plate 11, and a first included angle R1 is formed between a display surface S3 of the indicating mechanism 4 and the cutting plane S0, the first included angle R1 being greater than or equal to 20° and less than 90°.

With such a configuration, when the operator holds the first handle 12 and the second handle 13, precise guidance and stable support can be achieved at the end proximate to the cutting mechanism 2, while operational stability can be enhanced through the handle at the other end distal from the cutting mechanism 2, reducing shaking and deviation caused by one-handed holding. Simultaneously, the display surface S3 of the indicating mechanism 4 is inclined relative to the cutting plane S0 by the first included angle R1, positioning the indication information toward the operator's line of sight. This facilitates the operator in intuitively obtaining deflection information of the cutting plane S0 relative to the reference plane while maintaining a safe stance and normal grip posture. Consequently, the safety and precision of trimming operations are improved, and visual fatigue and wrist strain during prolonged operation are reduced.

In some embodiments, the first included angle R1 can be optimized based on the usage scenario and the operator's height and grip posture. For example, the first included angle R1 may range between 20° and 30° to suit trimming conditions where close proximity to the workpiece and a lower line of sight are required. In other embodiments, the first included angle R1 may range between 30° and 60°, giving the display surface S3 a more pronounced elevation relative to the cutting plane S0, which facilitates the operator in observing the indication information from above while standing. As another example, in further embodiments, the first included angle R1 may range between 60° and 80°, enabling clear reading of the display information from the indicating mechanism 4 even when maintaining a larger safety distance or using the tool in an inclined posture.

It should be understood that the specific value of the first included angle R1 is not limited to the several typical angles within the aforementioned exemplary ranges. As long as the first included angle R1 falls within the range greater than or equal to 20° and less than 90°, and allows the operator to conveniently observe the indication information in a conventional grip posture while ensuring that the display surface S3 of the indicating mechanism 4 is not obstructed by the protective plate 11, handles, or the operator's hands, it is considered to fall within the scope of protection of the present disclosure. In other embodiments, the first included angle R1 may be a fixed angle or adjustable within a preset range through an adjustable structure to adapt to different cutting postures and usage environments, thereby further enhancing the versatility and comfort of the trimming tool.

In some cases, in this embodiment, when the first included angle R1 is less than 20°, the display surface S3 is too close to the cutting plane S0 and is prone to being obstructed by the blade, the protective plate 11, or the plants being trimmed. Additionally, the user would need to observe the indication information within a very narrow viewing angle, increasing the difficulty of recognition. When the first included angle R1 exceeds 90°, the display surface S3 tends to face away from the user or become overly vertical, requiring the user to significantly twist his/her wrists or tilt his/her head upward to see the indication information, which can easily lead to operational fatigue and increase safety risks. Therefore, limiting the first included angle R1 to the range of 20° to 90° ensures that the display surface S3 avoids obstruction while remaining clearly visible in a natural grip posture, thereby achieving a reasonable balance among visibility, obstruction relations, and grip comfort. This parameter range is specifically determined to achieve the aforementioned comprehensive technical effects and is not merely a conventional adaptive adjustment of the angle of the display surface S3 for aesthetic appeal or installation convenience.

It should be noted that the “display surface S3 of the indicating mechanism 4” referred to here is a geometric plane where the visible area for displaying light signals and/or graphics and text information to the operator is located when the indicating mechanism 4 is in the installed state. Specifically, when the indicating mechanism 4 includes a light panel 41 and a plurality of light beads disposed thereon, the display surface S3 is a panel surface of the light panel 41 facing the operator. When the indicating mechanism 4 further includes a light-transmitting cover, the display surface S3 may be a geometric plane corresponding to an area for displaying the indication information on the operator-facing side of the light-transmitting cover.

In other embodiments of the present disclosure, referring to FIG. 5, an included angle of inclination R5 is formed between the reference plane (the second reference plane S2) perpendicular to the cutting plane S0 and a section extending along a length direction of the first handle 12, where the included angle of inclination R5 is in a range of 0° to 15°. By slightly tilting the first handle 12 within this range, the operator's forearm and wrist joint are brought closer to a neutral position during a normal grip posture, which can reduce the twist and flexion/extension range of the wrist joint and decrease the sustained force on the wrist and forearm muscles. At the same time, it facilitates the formation of a stable force triangle when both hands of the operator cooperate to hold the tool, improving the guiding capability and controllability of the trimming tool, thereby enhancing ergonomic characteristics and reducing fatigue during prolonged operation while ensuring cutting precision.

For example, the first handle 12 forms the included angle of inclination R5 relative to the reference plane (the second reference plane S2) perpendicular to the cutting plane S0. The included angle of inclination R5 may be 0° to 5°, where the first handle 12 is arranged substantially perpendicular to the cutting plane S0, making it more suitable for rough trimming conditions requiring greater pushing and pulling force; in other embodiments, the included angle of inclination R5 may be 5° to 10°, where the first handle 12 is moderately tilted relative to the reference plane, which helps reduce wrist deviation while maintaining smoothness in the pushing and pulling force path; as another example, in further embodiments, the included angle of inclination R5 may be 10° to 15°, which is more suitable for usage scenarios focused on fine guidance and light-pressure trimming, allowing for subtle adjustments by the operator while ensuring grip stability.

It should be noted that when the included angle of inclination R5 of the first handle 12 is less than 0°, i.e., the first handle 12 tilts away from the operator relative to the reference plane, it can easily cause the operator's wrist joint to experience adverse lateral deviation and torsion, resulting in an unnatural grip posture that is not conducive to prolonged operation. When the included angle of inclination R5 of the first handle 12 exceeds 15°, the first handle 12 tilts excessively toward the operator, increasing the rotational angle of the forearm and the lifting range of the shoulder, which instead increases muscle tension and may reduce stability during high-force pushing operations. In the present disclosure, limiting the included angle of inclination R5 of the first handle 12 to the range of 0° to 15° represents a balanced choice made after comprehensive consideration of the operator's ergonomic characteristics, typical working postures, and the operational stability of the trimming tool, taking into account both grip comfort and operational safety and controllability.

In some embodiments, a first included angle is formed between a display surface of the indicating mechanism and the cutting plane, where the first included angle is greater than or equal to 20° and less than 90°; and/or, an included angle of inclination is formed between the reference plane perpendicular to the cutting plane S0 and a section extending along a length direction of the first handle, where the included angle of inclination is in a range of 0° to 15°; and/or, a preset plane is defined between a bottom end of the indicating mechanism proximate to the housing and a top end of a gripping portion of the first handle, a second included angle is formed between the preset plane and the cutting plane, and the second included angle is between 0° and 90°; and/or, a third included angle is formed between a plane where a line connecting a top end of the first handle and a top end of the protective plate lies and a horizontal plane where the top end of the first handle lies, where the third included angle is between 10° and 45°; and/or, a fourth included angle is formed between a plane where a line connecting a vertex on a side portion of the first handle and a vertex on a side portion of the protective plate lies and the cutting plane, where the fourth included angle is between 0° and 35°; and/or, on a projection plane perpendicular to the cutting plane, a widest distance of a projection of the first handle is a first distance, and a widest distance of a projection of the indicating mechanism is a second distance. In some embodiments, the first distance ranges from 190 mm to 250 mm, the second distance ranges from 100 mm to 250 mm, and a ratio of the first distance to the second distance is between 1:1 and 1:2.5.

In this embodiment, by arranging the first handle at the end of the housing proximate to the cutting mechanism and the protective plate, and arranging the second handle at the other end of the housing distal from the cutting mechanism and the protective plate, two grip positions distributed front and rear are formed on the housing. When the user holds the trimming tool, the force application positions of both hands are separated along the length direction of the housing, which helps stabilize the overall posture of the tool during trimming and reduces unilateral force. When it is required to fine-tune the spatial posture of the cutting plane, the user can achieve finer adjustments through coordinated operation of the first handle and the second handle, making it easier to maintain the cutting plane in a state close to the target reference plane. By forming the first included angle between the display surface of the indicating mechanism and the cutting plane, and limiting the first included angle A to be greater than or equal to 20° and less than 90°, it reduces the likelihood of the display surface being approximately parallel to the cutting plane, which could cause the indication information to be blocked by a cutting area or plants. It also prevents the display surface from being too close to the vertical direction, which would require the user to significantly twist his/her wrist or line of sight to observe the indication information.

Such a configuration ensures that, in the normal trimming posture, the display surface is positioned where it can be observed within the user's natural line of sight or with only a slight shift in gaze. This facilitates simultaneously focusing on the cutting trajectory and the deflection indication without significantly altering the grip posture.

By limiting the angle of inclination B of the first handle relative to the reference plane perpendicular to the cutting plane within the range of 0° to 15°, the first handle can maintain a moderate degree of inclination while essentially aligning with the direction of the housing. This reduces the twist amplitude of the user's wrist joint during gripping and alleviates fatigue from prolonged operation. Simultaneously, the slight tilt of the first handle can make the posture changes of the trimming tool smoother and more controllable when the user performs slight rotation or lifting actions, facilitating fine adjustments to the deflection of the cutting plane.

By defining the preset plane between the bottom end of the indicating mechanism proximate to the housing and the top end of the gripping portion of the first handle, forming the second included angle between the preset plane and the cutting plane, and limiting the second included angle to between 0° and 90°, the relative spatial relationship between the indicating mechanism and the first handle in both the height and front-rear directions is constrained. This ensures that the indicating mechanism is neither positioned too low to be obstructed by the gripping hand or an object being trimmed nor too high to affect the tool's center of gravity and field of view. Thus, when the user naturally extends his/her arm and holds the first handle in a normal posture, the area where the preset plane lies falls within a spatial range that the user can easily focus on. This facilitates in obtaining deflection indication information while observing the cutting area.

By forming the third included angle between the plane where the line connecting the top end of the first handle and the top end of the protective plate lies and the horizontal plane where the top end of the first handle lies, and limiting this angle to between 10° and 45°, a reasonable height difference between the protective plate and the top end of the first handle in the vertical direction can be determined. This ensures that the protective plate has a sufficient height to carry the indicating mechanism and serve a protective function, yet is not elevated excessively to hinder the user's observation of the forward environment and cutting area.

By forming the fourth included angle between the plane where the line connecting the vertex on the side portion of the first handle and the vertex on the side portion of the protective plate lies and the cutting plane, and limiting the fourth included angle to between 0° and 35°, the relative offset relationship between the first handle and the protective plate in the left-right lateral direction can be defined. When the fourth included angle falls near a reasonable interval within this range, the protective plate has a certain amount of lateral deviation relative to the first handle. This helps reduce obstruction of the indicating mechanism by the gripping hand while avoiding excessive lateral offset that could cause significant torque when lateral force is applied to the trimming tool, thereby affecting control stability.

By setting the widest distance of the projection of the first handle on the projection plane perpendicular to the cutting plane as the first distance and limiting the first distance to between 190 mm and 250 mm, while setting the widest distance of the projection of the indicating mechanism as the second distance and limiting the second distance to between 100 mm and 250 mm, and constraining the ratio of the first distance to the second distance to between 1:1 and 1:2.5, a reasonable width proportion relationship is established between the grip area and the indication area. On the one hand, the range of the first distance ensures that the first handle has a sufficient grip width to accommodate different hand sizes and glove-wearing situations, without compromising grip stability due to being too narrow or causing the tool to be unwieldy due to excessive width; on the other hand, the range of the second distance ensures that the indicating mechanism has a sufficient width to arrange signal indication elements, without being so wide as to obstruct the field of view or significantly increase the front-end load.

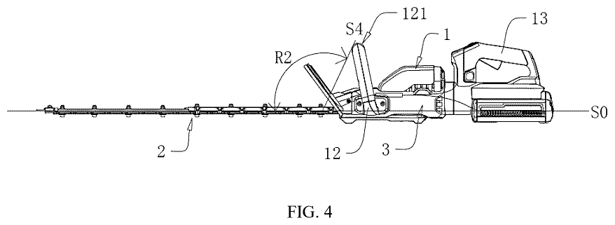

In some embodiments of the present disclosure, referring to FIG. 4, a preset plane S4 is defined between a bottom end of the indicating mechanism 4 proximate to the housing 1 and a top end of a gripping portion 121 of the first handle 12, a second included angle R2 is formed between the preset plane S4 and the cutting plane S0, and the second included angle R2 is between 0° and 90°. Through such a configuration, the relative height and spatial relationship between the indicating mechanism 4 and the first handle 12 in the longitudinal direction of the tool can be constrained. This makes it easier for the operator's line of sight to fall on the area where the indicating mechanism 4 is located when normally holding the first handle 12, thereby allowing the operator to intuitively obtain the deflection state of the cutting plane S0 relative to the reference plane without significantly altering the existing grip posture. Simultaneously, by limiting the range of the included angle between the preset plane S4 and the cutting plane S0, it helps ensure the visibility of the indication information while balancing the compactness of the overall structure and the arrangement space for elements inside the housing 1, thereby improving the ergonomic performance and structural efficiency of the entire tool.

For example, the second included angle R2 may be 0° to 30°, in which case the preset plane S4 is arranged substantially parallel to the cutting plane S0, which is suitable for scenarios where the tool is used in a low posture for push-pull trimming close to the workpiece surface, and the operator can see the indication information by slightly lowering his/her head. In other embodiments, the second included angle R2 may be 30° to 60°, in which case the preset plane S4 has a moderate angle of inclination relative to the cutting plane S0, which is suitable for most common working conditions in a standing posture and provides a good viewing angle while ensuring stable support in the front-rear direction of the tool. As another example, in further embodiments, the second included angle R2 may be 60° to 90°, in which case the preset plane S4 is nearly perpendicular to the cutting plane S0, which is more beneficial for clearly recognizing the display information of the indicating mechanism 4 even when the operator maintains a larger safety distance and observes the tool from the side or above.

It should be noted that when the second included angle R2 is too small, approaching 0°, the preset plane S4 nearly coincides with the cutting plane S0. In such cases, the indicating mechanism 4 has insufficient spacing from the first handle 12 in both height and front-rear directions, making it easily obstructed by the trimmed plants or the user's hands. It also does not provide adequate installation and visibility space for the indicating mechanism 4. When the second included angle R2 is too large, approaching or exceeding 90°, the preset plane S4 is elevated too high relative to the cutting plane S0. The height difference and front-rear offset between the indicating mechanism 4 and the first handle 12 become excessive, which not only raises the front-end center of gravity, reducing the stability of the entire tool during trimming, but may also obstruct the user's observation of the forward environment and cutting area. Therefore, limiting the second included angle R2 to the range of 0° to 90° ensures that the indicating mechanism 4 has an appropriate height difference and visible space while reducing center-of-gravity height and restricted field of view, thereby achieving a reasonable balance among the range of visibility, obstruction relations, and overall tool stability. This parameter range is specifically set to achieve the aforementioned comprehensive technical effects and is not merely a simple adaptive adjustment for aesthetic design or assembly convenience.

In some embodiments of the present disclosure, referring to FIG. 5, a third included angle R3 is formed between a plane where a line connecting a top end of the first handle 12 and a top end of the protective plate 11 lies and a horizontal plane where the top end of the first handle 12 lies, where the third included angle R3 is between 10° and 45°. By defining this third included angle R3, the height and front-rear positional relationship of the protective plate 11 relative to the first handle 12 can be reasonably determined in space. This ensures that while providing shielding and protection for the operator, the protective plate 11 does not excessively raise or lower its top end position, thereby reducing obstruction of the operator's line of sight. Simultaneously, a certain elevation angle is formed between the top end of the protective plate 11 and the top end of the first handle 12, which helps block flying debris and rebounding objects outside the safe area during trimming. Combined with an ergonomic grip height and line of sight direction, this enhances the safety and comfort of tool usage.

For example, the third included angle R3 may be 10° to 20°, in which case the top end of the protective plate 11 is slightly elevated relative to the top end of the first handle 12, which is suitable for working conditions primarily involving push-pull rough trimming that require a larger field of view; in other embodiments, the third included angle R3 may be 20° to 30°, in which case the top end of the protective plate 11 has a moderate height difference and front-rear positional difference relative to the top end of the first handle 12, making it more suitable for most fine trimming operations in a standing posture, thereby balancing shielding effectiveness with observation convenience; as another example, in further embodiments, the third included angle R3 may be 30° to 45°, in which case the top end of the protective plate 11 is more significantly elevated relative to the top end of the first handle 12, which is more beneficial for scenarios with more flying debris or requiring increased safety margins, thereby enhancing protection for the operator's face and upper limbs.

Specifically, when the third included angle R3 is less than 10°, the height difference between the top end of the first handle 12 and the top end of the protective plate 11 is too small, and the protective plate 11 is too close to the top end of the first handle 12. The indicating mechanism 4 struggles to form a noticeable protruding effect in the height direction and can easily be obstructed by the user's hands, arms, or front plants during trimming, hindering the timely and clear recognition of indication information. At the same time, the protective plate 11's ability to block flying debris is relatively weakened. When the third included angle R3 exceeds 45°, the protective plate 11 is elevated too high relative to the top end of the first handle 12, causing the front-end structure to protrude significantly in the vertical direction. This not only raises the front-end center of gravity, affecting the stability of the trimming tool during front-rear swinging, but may also obstruct the user's observation of the forward environment and cutting area, increasing operational inconvenience and safety hazards. Therefore, limiting the third included angle R3 to the range of 10° to 45° creates a moderate height difference between the protective plate 11 and the top end of the first handle 12. This positions the indicating mechanism 4 in a relatively prominent and visible location when the user grips the first handle 12, balancing indication readability with protective performance and overall tool stability. This angular range is a parameter constraint determined after comprehensive consideration of protective performance, field of view openness, and overall structural harmony, and is not merely a routine adjustment by simply raising or lowering the protective plate 11 position to match the appearance of different tool models.

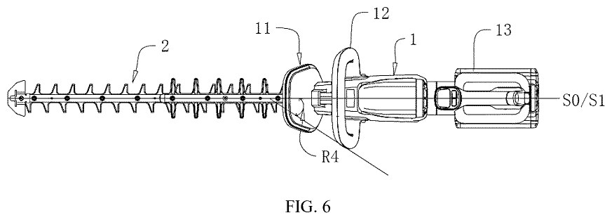

In some embodiments of the present disclosure, referring to FIG. 6, a fourth included angle R4 is formed between a plane where a line connecting a vertex on a side portion of the first handle 12 and a vertex on a side portion of the protective plate 11 lies and a reference plane (the second reference plane S2) perpendicular to the cutting plane S0, where the fourth included angle R4 is between 0° and 35°. By defining the fourth included angle R4, on the one hand, the relative height and offset relationship between the first handle 12 and the protective plate 11 in the lateral profile of the tool can be constrained, enabling the protective plate 11 to form an effective lateral shielding area on the side of the tool for blocking debris flying laterally along the cutting plane S0; on the other hand, it reduces excessive extension or retraction of the side portion of the protective plate 11 relative to the side portion of the first handle 12, ensuring that no significant lateral interference or squeezing occurs when the operator normally grips the first handle 12. Thus, while enhancing lateral protection capability, grip comfort, and ergonomic characteristics are also taken into account.

For example, the fourth included angle R4 may be 0° to 10°, in which case the plane where the line connecting the vertex on the side portion of the first handle 12 and the vertex on the side portion of the protective plate 11 lies has only a slight inclination relative to the cutting plane S0, which is suitable for working conditions requiring a more compact lateral profile of the entire tool and helps reduce the tool's lateral footprint; in other embodiments, the fourth included angle R4 may be 10° to 25°, in which case the side portion of the protective plate 11 has a suitable angle of inclination relative to the cutting plane S0, ensuring both the effectiveness of lateral shielding and the operator's visibility of the cutting area from different standing angles, more suitable for most conventional trimming postures; as another example, in further embodiments, the fourth included angle R4 may be 25° to 35°, in which case the side portion of the protective plate 11 has a more noticeable inclination relative to the cutting plane S0, which is more beneficial for use in scenarios with more flying debris or requiring increased lateral safety margins for the tool, thereby enhancing protection for the operator's lateral body parts.

Specifically, when the fourth included angle R4 approaches or even nears 0°, the plane where the line connecting the vertex on the side portion of the first handle 12 and the vertex on the side portion of the protective plate 11 lies is almost parallel to the cutting plane S0. The lateral offset of the protective plate 11 relative to the first handle 12 is small, making the indicating mechanism 4 more easily obstructed by the user's hands, forearms, or the side of the housing 1, resulting in insufficient lateral visibility, and the user may find it difficult to observe the indication information promptly in a conventional grip posture. When the fourth included angle R4 exceeds 35°, the lateral relative offset between the first handle 12 and the protective plate 11 becomes significant. The protective plate 11 and the indicating mechanism 4 as a whole are noticeably shifted to one side, which can easily cause a larger deflection torque when lateral force is applied to the trimming tool. The stability of the entire tool decreases during left-right swinging or sudden lateral impacts. Additionally, it may shift the indicating mechanism 4 away from the user's forward field of view, adversely affecting actual observation.

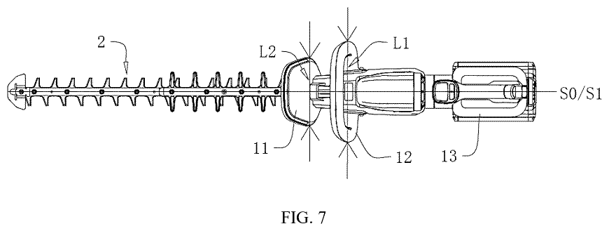

In some embodiments of the present disclosure, referring to FIG. 7, on a projection plane perpendicular to the cutting plane S0, a widest distance of a projection of the first handle 12 is a first distance L1, and a widest distance of a projection of the indicating mechanism 4 is a second distance L2, where the first distance L1 ranges between 190 mm and 250 mm, the second distance L2 ranges between 100 mm and 250 mm, and a ratio of the first distance L1 to the second distance L2 is between 1:1 and 1:2.5. By limiting the widest distances of the first handle 12 and the indicating mechanism 4 on the projection plane perpendicular to the cutting plane S0 within the above ranges and constraining the ratio between them, on the one hand, the first handle 12 is ensured to have a sufficient grip width, providing the operator with stable support and appropriate force distribution when the operator holds the first handle with both hands; on the other hand, the width of the indicating mechanism 4 on the projection plane matches that of the first handle 12. The width is not too narrow, which would result in a small indication information display area and poor readability, nor too wide, which would occupy excessive lateral space on the housing 1. This achieves a reasonable balance among grip comfort, overall structural compactness, and the visibility of the indication information.

For example, in some embodiments, the first distance L1 may be selected to be approximately 200 mm, and the second distance L2 may be selected to be approximately 200 mm, in which case the ratio between them is approximately 1:1, facilitating a harmonious and integrated appearance on the side of the housing 1; in other embodiments, the first distance L1 may be approximately 220 mm, and the second distance L2 may be approximately 240 mm, in which case the ratio between them is approximately 1:1.1, helping maintain a coordinated relationship with the width of the second handle 13 while slightly increasing the display width of the indicating mechanism 4; as another example, in further embodiments, the first distance L1 may be approximately 190 mm, and the second distance L2 may be approximately 250 mm, in which case the ratio between them is 1:1.32, providing the indicating mechanism 4 with a larger display width to improve visibility under complex working conditions.

As an example, the housing 1 is provided with a first handle 12 and a second handle 13, where the first handle 12 is disposed at one end of the housing 1 proximate to the cutting mechanism 2 and the protective plate 11, the second handle 13 is disposed at the other end of the housing 1 distal from the cutting mechanism 2 and the protective plate 11, and a first included angle R1 is formed between a display surface S3 of the indicating mechanism 4 and the cutting plane S0, the first included angle R1 being greater than or equal to 20° and less than 90°; and/or, an angle of inclination of the first handle 12 relative to a reference plane perpendicular to the cutting plane S0 is in a range of 0° to 15°; and/or, a preset plane S4 is defined between a bottom end of the indicating mechanism 4 proximate to the housing 1 and a top end of a gripping portion 121 of the first handle 12, a second included angle R2 is formed between the preset plane S4 and the cutting plane S0, and the second included angle R2 is between 0° and 90°; and/or, a third included angle R3 is formed between a plane where a line connecting a top end of the first handle 12 and a top end of the protective plate 11 lies and a horizontal plane where the top end of the first handle 12 lies, where the third included angle R3 is between 10° and 45°; and/or, a fourth included angle R4 is formed between a plane where a line connecting a vertex on a side portion of the first handle 12 and a vertex on a side portion of the protective plate 11 lies and the cutting plane S0, where the fourth included angle R4 is between 0° and 35°; and/or, on a projection plane perpendicular to the cutting plane S0, a widest distance of a projection of the first handle 12 is a first distance L1, and a widest distance of a projection of the indicating mechanism 4 is a second distance L2, where the first distance L1 ranges between 190 mm and 250 mm, the second distance L2 ranges between 100 mm and 250 mm, and a ratio of the first distance L1 to the second distance L2 is between 1:1 and 1:2.5.

In some embodiments of the present disclosure, referring to FIG. 3, the trimming tool further includes a first lead wire 6 and a second lead wire 7, where one end of the first lead wire 6 is electrically connected to the detection mechanism 5, and the first lead wire 6 is configured to transmit a deflection signal acquired by the detection mechanism 5 regarding the cutting plane S0 relative to the reference plane; the control mechanism 8 is electrically connected to the other end of the first lead wire 6 and is configured to output a display signal based on the deflection signal; one end of the second lead wire 7 is electrically connected to the control mechanism 8, and the other end of the second lead wire 7 extends to a middle area of the protective plate 11 and is electrically connected to an input terminal of any one set of the light panels 41; or, the other end of the second lead wire 7 extends to a side area of the protective plate 11 and is electrically connected to an input terminal of any one set of the light panels 41, and the second lead wire 7 is configured to load the display signal onto the light panels 41. By adopting the wiring arrangement of the first lead wire 6 and the second lead wire 7 described above, reliable electrical connections can be achieved among the detection mechanism 5, the control mechanism 8, and the light panels 41 on the protective plate 11 while maintaining structural compactness. On the one hand, the first lead wire 6 directly transmits the deflection signal of the cutting plane S0 relative to the reference plane between the detection mechanism 5 and the control mechanism 8, providing a clear signal path; on the other hand, the second lead wire 7 extends from the control mechanism 8 to the middle area or side area of the protective plate 11 and is electrically connected to the input terminal of any one set of the light panels 41. This arrangement allows a certain degree of freedom in the installation position of the light panels 41, facilitating flexible adjustment of the wiring path based on the layout of internal elements inside the housing 1 and the structural form of the protective plate 11. It also helps shorten cable lengths and avoid moving components such as the cutting mechanism 2 and high-interference areas, thereby enhancing wiring safety and anti-interference capability.

In some cases, the second lead wire 7 may optionally be routed inside the housing 1 or the protective plate 11 to reduce cable exposure, thereby lowering the risk of accidental snagging, wear, or cutting. This improves the overall reliability, assembly convenience, and ease of later maintenance of the tool.

In some embodiments of the present disclosure, the light panels 41 are provided with a plurality of light bead groups 411 thereon; and the operating state of the indicating mechanism 4 includes an illumination intensity and/or illumination position of the light bead groups 411, and/or a display color of the light bead groups 411. By controlling the combination of illumination, brightness levels, and color changes among different light bead groups 411, various types of information, such as the direction and angle of deflection of the cutting plane S0, and whether the angle exceeds a preset safe range, can be conveyed within a limited display area, thereby enhancing the readability and information-carrying capacity of the indicating mechanism 4.

In some embodiments, the angle of deflection of the cutting plane S0 can be reflected by the illumination intensity of different light beads within the light bead group 411. For example, one light bead group 411 may include at least three light beads, namely a first light bead, a second light bead, and a third light bead: when the angle of deflection of the cutting plane S0 is small, only the first light bead is illuminated, and/or illuminated with lower brightness, to indicate a small deflection, essentially within a safe range; when the angle of deflection of the cutting plane S0 increases further, both the first and second light beads are illuminated simultaneously, and/or the brightness of the second light bead is higher than that of the first light bead, to indicate that the angle of deflection is within a medium range, requiring the operator's attention for adjustment; and when the angle of deflection of the cutting plane S0 increases to a larger range, the first, second, and third light beads are all illuminated together, and/or the third light bead is illuminated with higher brightness or in a flashing manner, to indicate a large angle of deflection approaching or even reaching an upper limit of an allowable range, reminding the operator to adjust or stop work in a timely manner. It may also include scenarios where, when the cutting plane S0 is not deflected, the first light bead is illuminated; when the cutting plane S0 deflects leftward, the second light bead is illuminated, and the greater the angle of deflection, the higher the illumination intensity of the second light bead, or its color changes (e.g., from yellow to red); when the cutting plane S0 deflects rightward, the third light bead is illuminated, and the greater the angle of deflection, the higher the illumination intensity of the third light bead, or its color changes (e.g., from yellow to red). Here, the first light bead may also be disposed between the second light bead and the third light bead. It should be noted that the number of light beads, the illumination sequence, and the brightness variation method described above can be adjusted according to actual needs and do not limit the scope of protection of the present disclosure.

In other embodiments, the angle of deflection of the cutting plane S0 can be reflected by the illumination position of different light beads within the light bead group 411. For example, one light bead group 411 may include at least three light beads arranged sequentially along a preset direction, namely a first light bead, a second light bead, and a third light bead: when the angle of deflection of the cutting plane S0 is small, only the first light bead located near a preset reference position is illuminated, to indicate a small deflection, essentially within a safe range; when the angle of deflection of the cutting plane S0 increases further, the first light bead is turned off, and only the second light bead located at an intermediate position is illuminated, to indicate that the angle of deflection is within a medium range, requiring the operator's attention for adjustment; and when the angle of deflection of the cutting plane S0 increases to a larger range, only the third light bead located on a side distal from the reference position is illuminated, and/or the third light bead is displayed in a flashing manner, to indicate a large angle of deflection, reminding the operator to adjust or stop work in a timely manner. It should be noted that the number of light beads, the arrangement method, and the illumination positions corresponding to different angles of deflection described above can be adjusted according to actual needs. For example, finer subdivisions of deflection ranges can also be represented by simultaneously illuminating two or more light beads at different positions, and these variations do not limit the scope of protection of the present disclosure.

In some embodiments, the angle of deflection of the cutting plane S0 can be reflected by the display colors of the light beads within the light bead group 411. For example, one light bead group 411 may include at least three light beads, namely a first light bead, a second light bead, and a third light bead: when the angle of deflection of the cutting plane S0 is small, the first light bead displays a first color, such as green, to indicate a small deflection, essentially within a safe range; when the angle of deflection of the cutting plane S0 increases further, the second light bead displays a second color, such as yellow, to indicate that the angle of deflection is within a medium range, requiring the operator's attention for adjustment; and when the angle of deflection of the cutting plane S0 increases to a larger range, the third light bead displays a third color, such as red, and/or is displayed in a flashing red manner, to indicate a large angle of deflection, reminding the operator to adjust or stop work in a timely manner. It should be noted that the first, second, and third colors are not limited to the examples of green, yellow, and red colors mentioned above. Any color combinations that are easily distinguishable from each other may be selected according to actual needs, and these combinations do not limit the scope of protection of the present disclosure.

As an example, the indicating mechanism 4 includes only one light panel 41. The light panel 41 is disposed on the protective plate 11, optionally positioned where it is easily observable by the operator when normally holding the first handle 12 and the second handle 13. Along the length direction of the light panel 41, a first light bead, a second light bead, and a third light bead are arranged in sequence, collectively forming a first preset area for indicating the deflection state of the cutting plane S0. The detection mechanism 5 is configured to detect the angle of deflection of the cutting plane S0 relative to the reference plane and output a detection value, and the control mechanism 8 controls the illumination combination of the three light beads within the first preset area based on the detection value, thereby achieving graded indication of different degrees of deflection on the same light panel 41.

In some embodiments, one or more boundary values can be preset for the angle of deflection to divide the angle of deflection of the cutting plane S0 into three intervals: small deflection, medium deflection, and large deflection. For example, when the angle of deflection corresponding to the detection value from the detection mechanism 5 is small, such as within approximately 5°, only the first light bead is illuminated, and/or illuminated with lower brightness, serving as a first signal to indicate that the cutting plane S0 is essentially within a safe range; when the angle of deflection increases further, for example, within a medium range of approximately 5° to 15°, both the first and second light beads are illuminated simultaneously, and/or the brightness of the second light bead is higher than that of the first light bead, serving as a second signal to indicate that the angle of deflection has significantly increased, requiring the operator's attention for adjustment; and when the angle of deflection increases to a larger range, such as greater than approximately 15°, the first, second, and third light beads are all illuminated together, and/or the third light bead is illuminated with higher brightness or in a flashing manner, serving as a third signal to indicate a large angle of deflection, reminding the operator to adjust or stop work in a timely manner. It should be noted that the values of approximately 5° and 15° mentioned above are exemplary settings. The angle changes may, but are not limited to, increase or decrease in equal increments, increase or decrease proportionally, or increase or decrease irregularly, which are not specifically limited herein. In practical applications, the boundary angles and corresponding light bead illumination combinations can be adjusted based on the structural dimensions, usage scenarios, and safety requirements of different tools. As long as graded feedback on the angle of deflection is achieved through the illumination intensity of the light bead groups 411 on the same light panel 41, it falls within the scope of protection of the present disclosure.

In an embodiment, the horizontal light panel 41 disposed in the middle portion of the protective plate 11 can be used to indicate the deflection state of the cutting plane S0 relative to the first reference plane S1. When the detection value from the detection mechanism 5 corresponds to the angle of deflection of the cutting plane S0 relative to the first reference plane S1, the three light beads on the horizontal light panel 41 can be illuminated sequentially according to the boundary values of approximately 5° and 15° mentioned above: when the angle of deflection is within approximately 5°, only the first light bead near the center of the light panel is illuminated, indicating that the cutting plane S0 is basically within the target horizontal neutral range relative to the first reference plane S1; when the angle of deflection is within approximately 5° to 15°, both the first and second light beads are illuminated, with the brightness of the second light bead potentially higher than that of the first light bead, to indicate that the angle of deflection relative to the first reference plane S1 has significantly increased; and when the angle of deflection is greater than approximately 15°, the first, second, and third light beads are all illuminated together, and the third light bead may be illuminated with higher brightness or in a flashing manner, to indicate a large angle of deflection of the cutting plane S0 relative to the first reference plane S1.

In another embodiment, the lateral light panel 41 disposed on the left or right side of the protective plate 11 can be used to indicate the deflection state of the cutting plane S0 relative to the second reference plane S2. When the detection value from the detection mechanism 5 corresponds to the angle of deflection of the cutting plane S0 relative to the second reference plane S2, the light beads on the lateral light panel 41 are also illuminated in a graded manner according to the boundary values of approximately 5° and 15°: when the angle of deflection relative to the second reference plane S2 is small, only one light bead near the center of the light panel is illuminated, indicating that the deflection is within the allowable range; when the angle of deflection is within a medium range, two light beads on a side toward the direction of deflection are illuminated sequentially or with increased brightness; and when the angle of deflection exceeds a larger threshold, multiple light beads on the side toward the direction of deflection are illuminated simultaneously with higher brightness or in a flashing manner, to indicate that the deflection of the cutting plane S0 relative to the second reference plane S2 has exceeded the recommended range. To facilitate the differentiation of different reference planes, in some embodiments, the light panel 41 used for indicating the first reference plane S1 may employ a first color or a first flashing manner, while the light panel 41 used for indicating the second reference plane S2 may employ a different color or flashing manner. This allows the operator to intuitively distinguish between deflection information of the cutting plane S0 relative to the first reference plane S1 and the second reference plane S2.

It should be noted that the descriptions of the number of light panels 41 and their arrangement positions in the above embodiments are for illustrative purposes only and do not limit the present disclosure. For example, in some embodiments, the indicating mechanism 4 may include only one light panel 41, which is horizontally disposed on the protective plate 11 for indicating the deflection state of the cutting plane S0. In other embodiments, the indicating mechanism 4 may include two light panels 41, which are disposed on the two sides of the protective plate 11, respectively for indicating situations where the cutting plane S0 deflects to different sides. In further embodiments, the indicating mechanism 4 may also include three or more light panels 41, which are disposed on the middle portion and/or two sides of the protective plate 11 and/or on a portion of the housing 1 opposite the protective plate 11, as long as it facilitates the operator's observation of the indication information.

In some cases, the number of light bead groups 411 on the light panel 41 and the number of light beads contained within each light bead group 411 are also not limited to the examples described above. They may be increased, decreased, or adjusted according to actual needs. As long as the deflection state of the cutting plane S0 can be indicated through the illumination intensity, illumination position, and/or display color of the light bead groups 411, it falls within the scope of protection of the present disclosure.

In some embodiments of the present disclosure, based on the foregoing solution, the trimming tool further includes: a first lead wire, having one end electrically connected to the detection mechanism, the first lead wire being configured to transmit a deflection signal acquired by the detection mechanism regarding the cutting plane relative to the reference plane, where the control mechanism is electrically connected to the other end of the first lead wire and is configured to output a display signal based on the deflection signal; and a second lead wire, having one end electrically connected to the control mechanism and the other end electrically connected to an input terminal of any one set of the light panels, where the second lead wire is configured to load the display signal onto the light panels.

In this embodiment, by arranging the first lead wire, the control mechanism, and the second lead wire, the aforementioned structure functionally segments the electrical connection between the detection mechanism and the light panels: one end of the first lead wire is electrically connected to the detection mechanism and configured to transmit the deflection signal acquired by the detection mechanism regarding the cutting plane relative to the reference plane, which allows the deflection signal to be transmitted along an independent line after leaving the detection mechanism, helping to reduce the impact of external interference on the deflection signal; the control mechanism is electrically connected to the other end of the first lead wire, generating a display signal for driving the indicating mechanism based on the deflection signal, thereby realizing the conversion and logical processing of the deflection signal into the display signal; one end of the second lead wire is electrically connected to the control mechanism, and the other end thereof can be extended to the middle area or side area of the protective plate according to its structural layout and electrically connected to the input terminal of any one set of light panels, which enables the display signal to be flexibly loaded onto the light panels at different positions, allowing adjustment of the light panel installation position without changing the relative positions of the detection mechanism and the control mechanism, thereby adapting to different forms of protective plates or different indication area designs. Consequently, while ensuring a clear and reliable transmission path for the deflection signal, the light panels can be arranged closer to the cutting area and at a position easily observable by the user. This facilitates the real-time and intuitive indication of the deflection state of the cutting plane and reduces the user's reliance on subjective visual estimation and experience-based judgment.

Referring to FIGS. 1 and 2, a trimming tool includes a housing 1, a cutting mechanism 2, a driving mechanism 3, an indicating mechanism 4, and a detection mechanism 5, where the housing 1 is provided with a protective plate 11 thereon; both the cutting mechanism 2 and the driving mechanism 3 are disposed on the housing 1, the cutting mechanism 2 has a cutting plane S0, and the driving mechanism 3 is configured to drive the cutting mechanism 2 to operate; the indicating mechanism 4 is disposed on the protective plate 11 and is configured to indicate a deflection state of the cutting plane S0 relative to a reference plane; and the detection mechanism 5 is connected to the indicating mechanism 4 and is configured to detect the deflection state of the cutting plane S0 relative to the reference plane and output a detection signal, where the reference plane includes a first reference plane S1 and/or a second reference plane S2.

In this embodiment, after a user activates the driving mechanism 3, the driving mechanism 3 drives the cutting mechanism 2 disposed on the housing 1 to operate, causing the cutting mechanism 2 to perform rotational or reciprocating motion about a predetermined axis of rotation or along a predetermined motion trajectory, thereby forming the cutting plane S0 on a surface of a to-be-trimmed workpiece. During operation, the user holds the housing 1 with one hand or both hands, positioning the cutting plane S0 close to or near the target surface of the workpiece, and selects either the first reference plane S1 or the second reference plane S2 as a reference according to on-site requirements. The detection mechanism 5 detects the deflection state of the cutting plane S0 relative to the currently selected reference plane in real time during trimming and outputs a corresponding detection signal; upon receiving the detection signal from the detection mechanism 5, the indicating mechanism 4 converts it into an intuitive optical signal display, for example, by changing the number, position, and/or display color of illuminated light beads or light bead groups 411, so as to provide feedback to the user regarding a direction and degree of deflection of the cutting plane S0. This allows the user to fine-tune the tool's posture based on the indication status while maintaining a normal grip and safe stance, thereby completing trimming work for target planes or target angles.

Thus, the coordination of the above structure and motion offers several beneficial effects: on the one hand, by arranging the protective plate 11 on the housing 1 and arranging the indicating mechanism 4 on the protective plate 11, the indication information is positioned near the cutting area at an easily observable location; combined with the real-time detection by the detection mechanism 5 regarding the cutting plane S0 relative to the first reference plane S1 and/or the second reference plane S2, the tool's posture deviation from the expected plane can be dynamically reflected during trimming, which helps improve trimming precision and consistency. On the other hand, it enables the user to obtain the current cutting state without relying on visual estimation of the tool's posture, reducing biases that depend on experiential judgment and lowering the risk of operational errors caused by limited viewing angles, insufficient ambient light, or complex workpiece shapes, thereby enhancing operational safety.

In some embodiments, the first reference plane is a plane in which the cutting plane lies when the cutting plane is parallel to the horizontal plane, and the second reference plane is a plane in which the cutting plane lies when the cutting plane is perpendicular to the horizontal plane.

In this embodiment, during use, the user holds the housing to control the trimming tool, positioning the protective plate and the indicating mechanism thereon toward a to-be-trimmed object. The driving mechanism drives the cutting mechanism disposed on the housing to operate, thereby forming a cutting plane in space for trimming. During trimming, the user aligns the cutting plane approximately with the intended first reference plane and/or second reference plane based on operational requirements: when performing top horizontal trimming, the cutting plane is oriented to approach a posture parallel to the horizontal plane, with the plane in which the cutting plane lies corresponding to the first reference plane; when performing vertical surface trimming, the cutting plane is oriented to approach a posture perpendicular to the horizontal plane, with the plane in which the cutting plane lies corresponding to the second reference plane. During the trimming process, if the cutting plane deflects relative to the aforementioned reference planes due to changes in grip posture, uneven terrain, or operational movements, the detection mechanism detects the deflection state of the cutting plane relative to the first reference plane and/or the second reference plane in real time and outputs a detection signal to the connected indicating mechanism. The indicating mechanism then indicates the current deflection state at the location of the protective plate. Within the field of view facing the to-be-trimmed object, the user can directly perceive the deflection between the cutting plane and the reference plane and promptly adjust the tool's posture based on the indication result.

By arranging the cutting mechanism and the driving mechanism on the housing, along with the indicating mechanism on the protective plate, and incorporating the detection mechanism connected to the indicating mechanism to detect and indicate the deflection state of the cutting plane relative to the reference plane, on the one hand, the posture of the cutting plane is linked to a clear geometric reference, facilitating the selection of the corresponding reference plane in different operational scenarios (such as top horizontal trimming and side vertical trimming); on the other hand, the deflection state is automatically detected by the detection mechanism and provided as a detection signal to the indicating mechanism, which directly completes the indication in the front area of the protective plate. This reduces the need to rely solely on the operator's visual estimation of the blade posture or repeated adjustments of body position to determine horizontal/vertical alignment, thereby minimizing subjective human errors.

In this embodiment, when the indicating mechanism 4 is installed on the protective plate 11, the protective plate 11 may employ different structural forms to adapt to various installation methods and protective requirements. The protective plate 11 may be a single-layer structure or a double-layer structure.

In some embodiments, the protective plate 11 is a single-layer structure, and the single-layer protective plate 11 may be integrally formed from a metal sheet or engineering plastic sheet, with a mounting surface for mounting the indicating mechanism 4 formed on a side facing the operator. The indicating mechanism 4 may be directly fixed onto the mounting surface by means such as screw connection, snap-fit connection, or adhesion. The lead wires connected to the indicating mechanism 4 are routed through wire holes or openings formed in the protective plate 11 to the interior of the housing 1. The single-layer protective plate 11 features a simple structure, low manufacturing cost, and easy processing and assembly, making it suitable for situations where the mounting space for the indicating mechanism 4 is relatively limited.

In other embodiments, the protective plate 11 is a double-layer structure. The double-layer protective plate 11 includes a first protective layer 111 and a second protective layer 112 disposed sequentially along a front-to-rear direction of the trimming tool, where the first protective layer 111 faces the cutting mechanism 2, the second protective layer 112 faces the operator, and the first protective layer 111 and the second protective layer 112 are spaced apart, forming an accommodating space therebetween for accommodating the indicating mechanism 4. The indicating mechanism 4 is at least partially disposed inside the accommodating space, and a display surface S3 of the indicating mechanism 4 communicates with the outside through a window penetrating the second protective layer 112, facilitating observation by the operator; and electrical connection leads of the indicating mechanism 4 are wired inside the accommodating space and extend to the interior of the housing 1. The double-layer protective plate 11, on the one hand, reserves a mounting space for the indicating mechanism 4 without significantly increasing the overall outline dimensions of the trimming tool; on the other hand, it uses the first protective layer 111 to block debris splashed during the cutting process and utilizes the double-layer structure to enclose and protect the indicating mechanism 4 and leads thereof, thereby enhancing the protective performance and installation stability of the indicating mechanism 4.

In some embodiments, the housing includes a first housing provided with a first handle and a second housing provided with a second handle, the first housing being rotatably connected to the second housing; a sensing mechanism is disposed on the second housing and configured to acquire rotation information of the second housing or the first housing and output a rotation signal; and the control mechanism controls, based on the rotation signal, the indicating mechanism to provide an indication in a corresponding area according to the detection signal. For example, the sensing mechanism is disposed on the second housing and configured to acquire relative rotation information of the second housing and the first housing and output a rotation signal.

In some embodiments of the present disclosure, the indicating mechanism includes at least one light panel; the light panel is provided with a plurality of light bead groups thereon; and the operating state of the indicating mechanism includes an illumination intensity and/or illumination position of the light bead groups, and/or a display color of the light bead groups.

In some embodiments of the present disclosure, the protective plate includes a first protective layer and a second protective layer disposed sequentially along a front-to-rear direction of the trimming tool, where the first protective layer faces the cutting mechanism, the second protective layer faces the operator, the first protective layer and the second protective layer are spaced apart, forming an accommodating space therebetween for accommodating the indicating mechanism, and the indicating mechanism is at least partially disposed inside the accommodating space.

In some embodiments of the present disclosure, based on the foregoing solution, the trimming tool further includes a first damping unit, where one end of the first damping unit is connected to the driving mechanism, and the other end of the first damping unit is disposed inside the housing toward the driving mechanism, with a gap reserved between the first damping unit and an inner wall of the housing.

In some embodiments of the present disclosure, based on the foregoing solution, the first damping unit is made of a flexible material.

In some embodiments of the present disclosure, based on the foregoing solution, the first damping unit has a hollowed-out portion.

In some embodiments of the present disclosure, based on the foregoing solution, the trimming tool further includes a second damping unit disposed between the housing and the driving mechanism and configured to mitigate an impact of movement of the driving mechanism on the housing.

In some embodiments of the present disclosure, along a length direction of the first handle, a thickness of the second damping unit is between 2.9 mm and 3.5 mm.

In some embodiments of the present disclosure, the trimming tool further includes a third damping unit disposed between the housing and the cutting mechanism.

In some embodiments of the present disclosure, the trimming tool further includes a fourth damping unit disposed between the housing and the driving mechanism and configured to reduce the impact of movement of the driving mechanism on the housing.

In some embodiments of the present disclosure, the fourth damping unit is made of a soft rubber damping pad.

In some embodiments of the present disclosure, the trimming tool further includes a fifth damping unit disposed between the housing and the driving mechanism and configured to mitigate the impact of movement of the driving mechanism on the housing.

In some embodiments of the present disclosure, the fifth damping unit is made of a hard rubber damping pad.

Referring to FIGS. 1, 2, and 3, a trimming tool includes a housing 1, a detection mechanism 5, a first lead wire 6, a control mechanism 8, a cutting mechanism 2, a driving mechanism 3, a second lead wire 7, and an indicating mechanism 4, where the detection mechanism 5 is disposed on the housing 1 and configured to detect a deflection state of a cutting plane S0 relative to a reference plane and output a detection signal; one end of the first lead wire 6 is electrically connected to the detection mechanism 5 and configured to transmit the detection signal acquired by the detection mechanism 5; the control mechanism 8 is disposed on the housing 1, electrically connected to the other end of the first lead wire 6, and configured to output a display signal based on the detection signal; the cutting mechanism 2 is disposed on the housing 1 and has the cutting plane S0; the driving mechanism 3 is configured to drive the cutting mechanism 2 to operate; the second lead wire 7 and the indicating mechanism 4 are provided, with one end of the second lead wire 7 electrically connected to the control mechanism 8 and the other end of the second lead wire 7 connected to the indicating mechanism 4; and the second lead wire 7 is configured to load the display signal onto the indicating mechanism 4, where the indicating mechanism 4 is configured to indicate the deflection state of the cutting plane S0 relative to the reference plane based on the display signal.

In this embodiment, during use, the user holds the housing to control the trimming tool, and the driving mechanism operates and drives the cutting mechanism disposed on the housing to rotate or reciprocate, thereby forming the cutting plane for trimming. During the trimming process, the posture of the cutting plane relative to the reference plane may deflect due to factors such as uneven terrain and changes in hand posture. The detection mechanism disposed on the housing detects a deflection state of the cutting plane relative to the reference plane in real time and outputs a detection signal, which is transmitted via the first lead wire to the control mechanism on the housing. Based on the detection signal, the control mechanism generates a display signal corresponding to the current deflection state. The display signal is then loaded onto the indicating mechanism via the second lead wire, causing the indicating mechanism to provide a visual indication of the cutting plane's deflection state synchronously during tool operation. Under normal gripping and operating conditions, the user can determine whether the current posture requires adjustment based on the display of the indicating mechanism and accordingly correct the posture of the trimming tool.

By sequentially arranging the detection mechanism, the first lead wire, the control mechanism, and the second lead wire with the indicating mechanism on the housing, the detection, signal transmission, signal processing, and deflection indication are implemented in stages. On the one hand, this ensures that the deflection state of the cutting plane relative to the reference plane is reliably acquired in the form of a detection signal and transmitted to the control mechanism via the first lead wire for processing, which helps maintain a clear signal transmission path and strong anti-interference capability; on the other hand, the control mechanism uniformly outputs a display signal, which is then loaded onto the indicating mechanism via the second lead wire, facilitating flexible arrangement of the indicating mechanism without altering the installation position of the detection mechanism, thereby improving the adaptability of the overall tool structure.

The indicating mechanism provides an indication of the deflection state of the cutting plane based on the display signal, enabling the operator to obtain in real time whether the current posture deviates from the reference plane without relying on empirical visual estimation. This allows timely correction of trimming actions, improving the straightness and height consistency of the trimming trajectory and reducing the risk of operational errors. The aforementioned structure represents an overall optimized design of the signal detection, processing, and display chain, rather than merely a simple adaptive adjustment of wiring routes or display positions.

In this embodiment, after the trimming operation is initiated, the driving mechanism 3 drives the cutting mechanism 2 disposed on the housing 1 to operate, enabling the cutting mechanism 2 to form the cutting plane S0 for processing a workpiece. During the operation, the detection mechanism 5 detects the deflection state of the cutting plane S0 relative to the reference plane in real time, generating a corresponding detection signal; then, the detection signal is transmitted via the first lead wire 6 to the control mechanism 8 disposed on the housing 1; after performing calculations and judgments based on the detection signal, the control mechanism 8 outputs a display signal corresponding to the current deflection state. The display signal is transmitted via the second lead wire 7 to the indicating mechanism 4. According to the display signal, the indicating mechanism 4 displays information through preset illumination patterns, positional changes, and/or color changes, thereby providing an intuitive indication of the direction and degree of deflection of the cutting plane S0 relative to the reference plane. Based on the display result of the indicating mechanism 4, the operator can adjust the posture and movement path of the trimming tool in a timely manner, bringing the cutting plane S0 closer to the target reference plane and completing the trimming operation.

The aforementioned configuration delineates and electrically isolates the detection, computation, and display functions, which helps reduce interference and attenuation during signal transmission and improves the accuracy and response speed of deflection state detection and display. The first lead wire 6 and the second lead wire 7 are respectively used to transmit the detection signal and the display signal, ensuring a clear wiring path, and they can be flexibly arranged according to the internal structure of the housing 1, minimizing interference with moving components such as the cutting mechanism 2 and the driving mechanism 3, thereby enhancing the reliability of the overall tool wiring and the convenience of assembly and maintenance. Through the real-time visual feedback on the cutting plane S0's deflection state provided by the indicating mechanism 4, the operator can obtain the tool's posture deviation without relying on subjective visual estimation. This reduces operational errors, improves trimming precision and consistency, and, to some extent, decreases the operator's dependence on visual acuity and experience-based judgment during prolonged operation, thereby enhancing the safety of use and ergonomic performance.

In some embodiments of the present disclosure, the housing 1 includes a first housing 14 provided with a first handle 12 and a second housing 15 provided with a second handle 13, where the first handle 12 is disposed at one end proximate to the cutting mechanism 2, and the second handle 13 is disposed at the other end distal from the cutting mechanism 2; the protective plate 11 is disposed at the end of the housing 1 proximate to the cutting mechanism 2; the indicating mechanism 4 is disposed on the protective plate 11, or the indicating mechanism 4 is disposed on the housing 1 between the first handle 12 and the second handle 13. Compared to embodiments where the indicating mechanism 4 is fixed solely on the protective plate 11, the distinguishing feature of this embodiment is that the installation position of the indicating mechanism 4 may optionally be between the protective plate 11 and an area of the housing 1 corresponding to the first handle 12 and the second handle 13: on the one hand, when the indicating mechanism 4 is disposed on the protective plate 11, it is closer to the cutting area, facilitating direct observation during operation near a workpiece; on the other hand, when the indicating mechanism 4 is disposed on the housing 1 between the first handle 12 and the second handle 13, it is closer to the area where the operator's hands are located, which is beneficial for obtaining a more comfortable viewing angle under different grip postures and standing angles while facilitating the optimization of wiring and installation space based on the layout of internal elements inside the housing 1. Thus, by flexibly selecting the installation position of the indicating mechanism 4 between the protective plate 11 and the corresponding area of the housing 1, a better balance can be achieved among indication visibility, structural layout rationality, and ergonomic performance, all of which fall within the scope of protection of the present disclosure.

In some embodiments of the present disclosure, the first housing 14 is rotatably connected to the second housing 15 (it is understandable that during use, the operator holds the second handle 13 on the second housing 15, keeping the second handle 13 and the second housing 15 it is located on essentially stationary in space. Based on operational needs, the operator applies force to rotate the first housing 14 provided with the first handle 12 and the cutting mechanism 2, relative to the second housing 15, thereby changing the posture of the cutting plane S0 relative to the reference plane.); and the detection mechanism 5 is electrically connected to the indicating mechanism 4 and is configured to detect the deflection state of the cutting plane S0 relative to the reference plane and output a detection signal. In this embodiment, before the trimming tool operates, the operator can first adjust the rotational position of the first housing 14 relative to the second housing 15 based on his/her height and grip habit, as well as the spatial posture of a to-be-trimmed object, positioning the first handle 12 and the cutting mechanism 2 at a spatial angle suitable for the current operational posture; after adjustment, the operator holds the first handle 12 and the second handle 13 with one or both hands, providing stable support through the second housing 15 and guidance through the first housing 14; the driving mechanism 3 drives the cutting mechanism 2 to operate, forming the cutting plane S0 for trimming. Meanwhile, the detection mechanism 5 detects the deflection state of the cutting plane S0 relative to the reference plane in real time and outputs a detection signal to the indicating mechanism 4; and the indicating mechanism 4 displays optical signals based on the detection signal (e.g., distinguished by the illumination intensity, illumination position, and/or display color of the light bead groups 411), ensuring that even when the first housing 14 is in different rotational positions relative to the second housing 15, the direction and degree of deflection of the cutting plane S0 can still be intuitively fed back, thereby facilitating timely adjustment of the trimming posture by the operator.

In some embodiments of the present disclosure, based on the foregoing solution, the protective plate includes a first protective layer and a second protective layer disposed sequentially along a front-to-rear direction of the trimming tool, where the first protective layer faces the cutting mechanism, the second protective layer faces the operator, the first protective layer and the second protective layer are spaced apart, forming an accommodating space therebetween for accommodating the indicating mechanism, and the indicating mechanism is at least partially disposed inside the accommodating space.

By rotatably connecting the first housing 14 to the second housing 15, the second handle 13 remains essentially stationary as a primary gripping portion during use. In different operational scenarios (such as high-position trimming, low-position trimming, wall-side trimming, or trimming in confined spaces), the operator can rotate the housing portion provided with the first handle 12 and the cutting mechanism 2 relative to the second handle 13 while firmly holding the second handle 13. This allows adjustment of the relationship between the cutting plane S0 and the target plane with a more natural forearm and wrist posture, reducing joint torsion and muscle strain and enhancing ergonomic comfort. At the same time, when a change in trimming direction or overall tool posture is needed, the operator can regain stable force support and an appropriate cutting posture simply by adjusting the rotational angle of the first housing 14, improving the controllability and stability of the entire tool. Additionally, when the tool is not in use, the first housing 14 can be rotated relative to the second housing 15 to a position close to the second handle 13, which helps reduce the overall external dimensions of the tool, facilitating storage and transportation.

It should be noted that, compared to embodiments where the second handle 13 is fixedly disposed on the housing 1 and the overall posture of the housing 1 remains essentially fixed relative to the second handle 13, the distinguishing feature of this embodiment is as follows: the housing 1 includes the first housing 14 and the second housing 15, where the first housing 14 is provided with the first handle 12 and the cutting mechanism 2, the second housing 15 is provided with the second handle 13, and the first housing 14 is rotatably connected relative to the second housing 15. During use, the operator primarily holds the second handle 13 disposed on the second housing 15, keeping the second housing 15 essentially stationary in space, and applies force to rotate the first housing 14 relative to the second housing 15, thereby changing the spatial posture of the cutting plane S0. While maintaining the electrical connection relationship between the detection mechanism 5 and the indicating mechanism 4, as well as the real-time indication function for the deflection state of the cutting plane S0 relative to the first reference plane S1 and/or the second reference plane S2, by introducing the aforementioned relative rotation structure between the first housing 14 and the second housing 15, the same set of detection and indication solutions can adapt to a wider variety of grip postures and usage environments, thereby enhancing the ergonomic comfort and applicability of the trimming tool without increasing the complexity of the core detection and display functions.

In some embodiments of the present disclosure, the indicating mechanism 4 includes at least one set of light panels 41, where one end of the second lead wire 7, distal from the control mechanism 8, extends to a middle area of the protective plate 11 and is electrically connected to an input terminal of any one set of the light panels 41; or, the end of the second lead wire 7, distal from the control mechanism 8, extends to a side area of the protective plate 11 and is electrically connected to the input terminal of any one set of the light panels 41, and the second lead wire 7 is configured to load the display signal onto the light panels 41.

In some cases, in this embodiment, the first housing 14 can rotate relative to the second housing 15 among at least three preset angular positions, the second handle 13 is disposed on the second housing 15 and remains essentially stationary as a primary gripping portion during use, the detection mechanism 5 is always configured to detect the deflection state of the cutting plane S0 relative to a selected reference plane and output a detection value, and the control mechanism 8 then selects a corresponding light panel 41 and its preset area for graded indication based on the current position of the first housing 14 relative to the second housing 15.

Specifically, when the first housing 14 is in a first position relative to the second housing 15, the control mechanism 8 compares the detection value output by the detection mechanism 5 with a preset first threshold: when the angle of deflection corresponding to the detection value is small, for example, within approximately 5°, a single light bead is illuminated in a first preset area on the horizontal light panel 41 as a first signal; when the angle of deflection corresponding to the detection value increases further, for instance, within approximately 5° to 15°, two light beads are illuminated in the first preset area as a second signal; and when the angle of deflection corresponding to the detection value increases to a larger range, such as greater than approximately 15°, three light beads are illuminated in the first preset area, with the third light bead optionally illuminated with higher brightness or in a flashing manner as necessary, as a third signal.

When the first housing 14 rotates to a second position relative to the second housing 15, the detection mechanism 5 continues to detect the deflection state of the cutting plane S0 relative to the reference plane and output a detection value, and the control mechanism 8 then selects a second preset area on the light panel 41 located on one side of the protective plate 11 corresponding to the second position for display: when the angle of deflection corresponding to the detection value is small (e.g., within approximately 5°), a single light bead is illuminated in the second preset area as a first signal; when the angle of deflection is within a medium range (e.g., approximately 5° to 15°), two light beads are illuminated in the second preset area as a second signal; and when the angle of deflection is large (e.g., greater than approximately 15°), three light beads are illuminated in the second preset area as a third signal.

When the first housing 14 rotates to a third position relative to the second housing 15, the detection mechanism 5 continues to output a detection value reflecting the deflection state, and the control mechanism 8 selects a third preset area on the light panel 41 located on the other side of the protective plate 11 corresponding to the third position for graded display: when the angle of deflection corresponding to the detection value is small, a single light bead is illuminated in the third preset area as a first signal; when the angle of deflection is within a medium range, two light beads are illuminated in the third preset area as a second signal; and when the angle of deflection is large, three light beads are illuminated in the third preset area as a third signal.

For example, in an embodiment, the reference plane can be set as the first reference plane S1. In this case, the detection value output by the detection mechanism 5 corresponds to the angle of deflection of the cutting plane S0 relative to the first reference plane S1: when the first housing 14 is in the first position, graded indication can optionally be achieved through the horizontal light panel 41 in the middle portion of the protective plate 11; when the first housing 14 is in the second or third position, graded indication is respectively achieved through the preset areas corresponding to the light panel 41 on the left or right side of the protective plate 11, and the operator can determine the degree of deflection of the cutting plane S0 relative to the first reference plane S1 based on the number of light beads and/or brightness variation.

In another embodiment, the reference plane can be set as the second reference plane S2. In this case, the detection value output by the detection mechanism 5 corresponds to the angle of deflection of the cutting plane S0 relative to the second reference plane S2: the light panel 41 on one side of the protective plate 11 can be configured primarily to indicate the deflection state relative to the second reference plane S2, while the light panel 41 in the middle portion or on the other side can be configured to indicate the deflection state relative to the first reference plane S1; the “one-light, two-light, three-light” grading method is still used to distinguish between the three intervals of small deflection, medium deflection, and large deflection; additionally, the deflection information corresponding to the first reference plane S1 and the second reference plane S2 can be distinguished by differences in the color, brightness, and/or flashing patterns of the light bead groups 411.

It should be noted that the values of approximately 5° and 15° mentioned above are only exemplary. The specific values of the first, second, and third thresholds, as well as the illumination combinations of the light beads in each preset area, can be adjusted according to actual product and safety requirements. As long as the graded indication of the degree of deflection of the cutting plane S0 relative to a selected reference plane is achieved within corresponding preset areas through the illumination intensity of “one light, two lights, three lights” based on the detection value from the detection mechanism 5 and at different preset positions of the first housing 14 relative to the second housing 15, it falls within the scope of protection of the present disclosure.

In some embodiments of the present disclosure, the indicating mechanism includes at least one light panel; the light panel is provided with a plurality of light bead groups thereon; and the operating state of the indicating mechanism includes an illumination intensity and/or illumination position of the light bead groups, and/or a display color of the light bead groups.

In some embodiments of the present disclosure, the protective plate includes a first protective layer and a second protective layer disposed sequentially along a front-to-rear direction of the trimming tool, where the first protective layer faces the cutting mechanism, the second protective layer faces the operator, the first protective layer and the second protective layer are spaced apart, forming an accommodating space therebetween for accommodating the indicating mechanism, and the indicating mechanism is at least partially disposed inside the accommodating space.

In some embodiments of the present disclosure, the trimming tool further includes a first damping unit, where one end of the first damping unit is connected to the driving mechanism, and the other end of the first damping unit is disposed inside the housing toward the driving mechanism, with a gap reserved between the first damping unit and an inner wall of the housing.

In some embodiments of the present disclosure, based on the foregoing solution, the first damping unit is made of a flexible material. In some embodiments of the present disclosure, the first damping unit has a hollowed-out portion.

In some embodiments of the present disclosure, the trimming tool further includes a second damping unit disposed between the housing and the driving mechanism and configured to mitigate an impact of movement of the driving mechanism on the housing.

In some embodiments of the present disclosure, along a length direction of the first handle, a thickness of the second damping unit is between 2.9 mm and 3.5 mm.

In some embodiments of the present disclosure, the trimming tool further includes a third damping unit disposed between the housing and the cutting mechanism.

In some embodiments of the present disclosure, the trimming tool further includes a fourth damping unit disposed between the housing and the driving mechanism and configured to mitigate the impact of movement of the driving mechanism on the housing.

In some embodiments of the present disclosure, the fourth damping unit is made of a soft rubber damping pad.

In some embodiments of the present disclosure, the trimming tool further includes a fifth damping unit disposed between the housing and the driving mechanism and configured to mitigate the impact of movement of the driving mechanism on the housing.

In some embodiments of the present disclosure, the fifth damping unit is made of a hard rubber damping pad.

In some embodiments of the present disclosure, the housing includes a first housing provided with a first handle and a second housing provided with a second handle, where the first handle is disposed at one end of the trimming tool proximate to the cutting mechanism, and the second handle is disposed at the other end of the trimming tool distal from the cutting mechanism; and the indicating mechanism is disposed on the protective plate, or the indicating mechanism is disposed on the housing corresponding to the first handle and the second handle.

In some embodiments of the present disclosure, the indicating mechanism is disposed on the protective plate, one end of the first lead wire is electrically connected to the detection mechanism, and the first lead wire is configured to transmit a deflection signal acquired by the detection mechanism regarding the cutting plane relative to the reference plane; the control mechanism is electrically connected to the other end of the first lead wire and is configured to output a display signal based on the deflection signal; one end of the second lead wire is electrically connected to the control mechanism, and the other end of the second lead wire extends to a middle area of the protective plate to be electrically connected to the indicating mechanism; or, the other end of the second lead wire extends to a side area of the protective plate to be electrically connected to the indicating mechanism, and the second lead wire is configured to load the display signal onto the indicating mechanism.

In some embodiments of the present disclosure, the second handle is rotatably connected to the housing; the trimming tool further includes a sensing mechanism, where the sensing mechanism is disposed on the housing and configured to acquire rotation information of the second handle and output a rotation signal; and the control mechanism controls, based on the rotation signal, the indicating mechanism to provide an indication in a corresponding area according to the detection signal. In some embodiments of the present disclosure, based on the foregoing solution, the housing includes a first housing provided with a first handle and a second housing provided with a second handle, where the first handle is disposed at one end of the housing proximate to the cutting mechanism, and the second handle is disposed at the other end of the housing distal from the cutting mechanism; the protective plate is disposed at the end of the housing proximate to the cutting mechanism; the indicating mechanism is disposed on the protective plate, or the indicating mechanism is disposed on the housing between the first handle and the second handle.

In this embodiment, by arranging the housing having the first housing provided with the first handle and the second housing provided with the second handle, and arranging the first handle at one end proximate to the cutting mechanism and the second handle at the other end distal from the cutting mechanism, the user can adopt a two-handed grip posture distributed front and rear during trimming. The first handle is closer to the cutting mechanism, facilitating precise control over the height and posture of the cutting plane, while the second handle provides auxiliary support and stabilizes the entire tool, helping to reduce the force exerted on a single hand and postural sway during prolonged operation. Simultaneously, by arranging the protective plate at the end of the housing proximate to the cutting mechanism and arranging the indicating mechanism on the protective plate or on the housing between the first handle and the second handle, the indicating mechanism is positioned within the field of view between or in front of the two handles. In the conventional posture of facing a to-be-trimmed object and holding the trimming tool with both hands, the user can directly observe the indication information without significant body rotation or looking down at the rear area, thereby enhancing the visibility and timeliness of the deflection state prompt. The protective plate not only blocks flying debris and shields the cutting mechanism but also provides a stable mounting reference for the indicating mechanism, integrating the safety protection and posture indication functions effectively in the front area.

The overall arrangement of the first handle, the second handle, the protective plate, and the indicating mechanism is a collaborative design based on comprehensive consideration of force balance, ergonomic grip posture, safety protection, and field of view. It effectively enhances the control stability during trimming and the intuitiveness of deflection indication, rather than being a simple adaptive adjustment of handle positions or display positions.

In some embodiments of the present disclosure, the first housing is rotatably connected to the second housing; a sensing mechanism is disposed on the second housing and configured to acquire relative rotation information of the second housing or the first housing and output a rotation signal; and the control mechanism controls, based on the rotation signal, the indicating mechanism to provide an indication in a corresponding area according to the detection signal.

In this embodiment, during use, the operator can primarily hold the second handle, keeping the second handle and its corresponding housing relatively stable in space. By applying force, the operator rotates the first housing provided with the first handle, relative to the second housing provided with the second handle, to adapt to different working postures, operational directions, and hand size requirements. Thus, when working in conditions such as trimming high, low, or lateral branches, the wrist joint and forearm can be positioned within a more suitable angular range, helping to reduce fatigue from prolonged operation and improve grip stability.

Before actual use, the operator can pre-adjust the rotational angle of the first housing corresponding to the first handle relative to the second housing corresponding to the second handle based on the height and spatial orientation of a target branch. During this rotation process, the sensing mechanism acquires relative rotation information of the second housing or the first housing and outputs a rotation signal, based on which the control mechanism selects an indication area corresponding to the current posture and, in conjunction with the detection signal output by the detection mechanism, drives the indicating mechanism to display in the corresponding area. This guides the operator to adjust the overall posture of the trimming tool, keeping the cutting plane within the desired deflection range. In some cases, during the trimming process, if the work object or direction changes, the operator can continue to fine-tune the rotational angle. The indicating mechanism synchronously updates the display result, reducing the operator's reliance on subjective feel when determining the direction and degree of deflection of the cutting plane. This enables more precise control over the cutting posture while maintaining grip comfort, thereby balancing ergonomic comfort with cutting posture control accuracy and improving operability and consistency across different postures.

In some embodiments of the present disclosure, based on the foregoing solution, the indicating mechanism includes at least one set of light panels, where one end of the second lead wire, distal from the control mechanism, is electrically connected to an input terminal of any one set of the light panels; and the second lead wire is configured to load the display signal onto the light panels.

In this embodiment, with the aforementioned configuration, the end of the second lead wire distal from the control mechanism can selectively extend to the middle area or side area of the protective plate and be electrically connected to the input terminal of any one set of light panels, enabling the display signal to be flexibly loaded onto light panels at different positions. On the one hand, the middle area is closer to the forward visual axis of the trimming tool, making it suitable for providing intuitive deflection indication to the user in forward trimming scenarios; on the other hand, the side area helps reduce partial obstruction by plants, hands, or the housing in certain trimming postures or specific structural layouts, thereby improving the visibility of the light panels under different working conditions. At the same time, the second lead wire serves only as a transmission path for the display signal, orderly guiding the display signal output by the control mechanism to the target light panels without altering the installation positions of the control mechanism and other circuit units. This facilitates standardized and modular design of wiring harness layout and enables the reuse of the same control circuit solution across different tool models and protective plate shapes. In some embodiments of the present disclosure, based on the foregoing solution, the light panels are provided with a plurality of light bead groups thereon; and the operating state of the indicating mechanism includes an illumination intensity and/or illumination position of the light bead groups, and/or a display color of the light bead groups.

Referring to FIGS. 1, 2, and 3, a trimming tool includes a housing 1, a cutting mechanism 2, a driving mechanism 3, an indicating mechanism 4, a sensing mechanism 9, and a control mechanism 8, where the housing 1 includes a first housing 14 provided with a first handle 12 and a second housing 15 provided with a second handle 13; the first housing 14 is rotatably connected to the second housing 15; both the cutting mechanism 2 and the driving mechanism 3 are disposed on the housing 1, the cutting mechanism 2 has a cutting plane S0, and the driving mechanism 3 is configured to drive the cutting mechanism 2 to operate; the indicating mechanism 4 is disposed on the housing 1 corresponding to the first handle 12 and the second handle 13, and is configured to indicate a deflection state of the cutting plane S0 relative to a reference plane; the sensing mechanism 9 is disposed at a rotating shaft between the first housing 14 and the second housing 15 and is configured to acquire relative rotation information of the first housing 14 or the second housing 15 and output a rotation signal; and the control mechanism 8 controls, based on the rotation signal, the indicating mechanism 4 to provide an indication in an area corresponding to the current posture, where a straight line extending along a length direction of the cutting plane S0 and parallel to the reference plane serves as a deflection axis, and the deflection state refers to a state in which the cutting plane S0 is deflected relative to the reference plane about the deflection axis.

In this embodiment, during use, the user holds the first handle and the second handle on the housing respectively, and the driving mechanism drives the cutting mechanism to operate, enabling the cutting plane to trim target branches. Since the first housing and the second housing are rotatably connected, when the user applies force to rotate the first housing relative to the second housing based on operational needs and site conditions, the posture of the first housing relative to the second handle changes accordingly. This causes the cutting plane to deflect relative to the reference plane about a deflection axis extending along the length direction of the cutting plane and parallel to the reference plane. During the rotation of the first housing relative to the second housing, the sensing mechanism disposed on the housing acquires rotation information of the first housing relative to the second housing (or, certainly, rotation information of the second housing relative to the first housing) and outputs a rotation signal. Based on the rotation signal, the control mechanism selects a preset area corresponding to the current posture on the indicating mechanism and, in combination with the detection signal output by the detection mechanism, drives the indicating mechanism to display within the selected preset area. This enables the user, after adjusting the rotational position of the first housing, to still intuitively obtain the deflection of the cutting plane relative to the reference plane in an area near the hand, and accordingly continue to rotate the angle of the first housing relative to the second housing, thereby adjusting the cutting plane to a posture close to the desired reference plane.

By designing the first housing provided with the first handle to be rotatably connected to the second housing provided with the second handle, and arranging the sensing mechanism on the housing to acquire rotation information of the first housing relative to the second housing, the control mechanism selects a preset area of the indicating mechanism based on the rotation signal and drives the selected preset area to provide an indication based on the detection signal from the detection mechanism. This establishes a correspondence between the rotational position of the first housing and the display position of the indication area, and presents the indication information reflecting the deflection state of the cutting plane visually near the user's grip area. As a result, the user can grasp the spatial deflection of the cutting plane in real time without relying solely on visual estimation of the blade posture or subjective experience. By adjusting the rotational angle of the first housing, fine-tuning of the cutting plane's posture can be achieved. Under different working postures and trimming directions, this helps maintain the cutting plane within an allowable range close to the reference plane, improving the straightness and consistency of trimming lines, reducing the risk of operational errors, and enhancing grip comfort during prolonged operation.

Before use, the operator can first rotate the first housing 14 around its rotating shaft relative to the second housing 15 to a comfortable working posture based on his/her height, stance, and working direction. This positions the first handle 12 and the cutting mechanism 2 disposed on the first housing 14 in a convenient operational location, while the second housing 15 and the second handle 13 disposed thereon remain essentially stationary in space. During the rotation of the first housing 14 relative to the second housing 15, the sensing mechanism 9 acquires the rotation information of the first housing 14 in real time and outputs a rotation signal to the control mechanism 8 (certainly, the sensing mechanism 9 can also acquire the rotation information of the second housing 15 in real time and output a rotation signal to the control mechanism 8). Subsequently, the operator holds the second handle 13 on the second housing 15 and the first handle 12 on the first housing 14 with both hands, and activates the driving mechanism 3, which drives the cutting mechanism 2 to operate, forming the cutting plane S0 for trimming. During the trimming process, the cutting plane S0 deflects relative to the reference plane about a deflection axis extending along the length direction of the cutting plane S0 and parallel to the reference plane. Based on the rotation signal output by the sensing mechanism 9, the control mechanism 8 controls the indicating mechanism 4 disposed on the first housing 14 and the second housing 15 to provide an indication in the corresponding area according to a preset correspondence. This ensures that, regardless of the angular position of the first housing 14 relative to the second housing 15, the deflection state of the cutting plane S0 relative to the reference plane can be intuitively displayed in an area close to the operator, facilitating continuous observation and adjustment of the trimming posture.

This configuration, by enabling the first housing 14 to rotate relative to the second housing 15 and arranging the sensing mechanism 9 at the rotating shaft therebetween to acquire the relative rotation information of the first housing 14 or the second housing 15 in real time, allows the spatial posture of the first handle 12 and the cutting mechanism 2 to be flexibly adjusted according to different working conditions (such as high-position trimming, low-position trimming, wall-side trimming, or trimming in confined spaces) while the second handle 13 and the second housing 15 it is located on serve as the primary grip reference and remain essentially stationary during use. As a result, the operator's forearm and wrist joint can be maintained in a comfortable and neutral posture as much as possible, reducing joint torsion and muscle strain and significantly improving ergonomic characteristics. Secondly, the control mechanism 8 selects and controls the working area of the indicating mechanism 4 based on the rotation signal, causing the indicating mechanism 4 to provide an indication within an area matching the current grip posture. This reduces reading difficulties that may arise when the original indication area shifts to a less observable position after the first housing 14 is rotated, thereby enhancing the visibility and readability of the indication information while maintaining the overall compact structure of the tool. Thirdly, by uniformly defining the deflection state as the state in which the cutting plane S0 is deflected relative to the reference plane about a deflection axis extending along its length direction and parallel to the reference plane, the angle of deflection is determined independently of the operator's grip style, the relative rotational posture between the first housing 14 and the second housing 15, and the overall flipping posture of the tool. This ensures consistent criteria for determining the deflection state across different postures, which helps improve the repeatability and consistency of trimming results, overall balancing operational safety, comfort, and trimming accuracy.

In some embodiments of the present disclosure, the indicating mechanism 4 includes at least one set of light panels 41; the light panels 41 are provided with a plurality of light bead groups 411 thereon; and the indicating mechanism 4 indicates, according to a signal loaded by the sensing mechanism 9, an illumination intensity and/or illumination position of the light bead groups 411, and/or a display color change of the light bead groups 411.

Specifically, the indicating mechanism 4 is disposed on the housing 1 corresponding to the first handle 12 and the second handle 13, and can reflect an angle of deflection of the cutting plane S0 through the illumination intensity of different light beads within the light bead groups 411 disposed thereon. For example, one light bead group 411 may include at least three light beads, namely a first light bead, a second light bead, and a third light bead: when the angle of deflection of the cutting plane S0 is small, only the first light bead is illuminated, and/or illuminated with lower brightness, to indicate a small deflection, essentially within a safe range; when the angle of deflection of the cutting plane S0 increases further, both the first and second light beads are illuminated simultaneously, and/or the brightness of the second light bead is higher than that of the first light bead, to indicate that the angle of deflection is within a medium range, requiring the operator's attention for adjustment; and when the angle of deflection of the cutting plane S0 increases to a larger range, the first, second, and third light beads are all illuminated together, and/or the third light bead is illuminated with higher brightness or in a flashing manner, to indicate a large angle of deflection approaching or even reaching an upper limit of an allowable range, reminding the operator to adjust or stop work in a timely manner. It should be noted that the number of light beads, the illumination sequence, and the brightness variation method described above can be adjusted according to actual needs and do not limit the scope of protection of the present disclosure.

The angle of deflection of the cutting plane S0 can also be reflected by the illumination position of different light beads within the light bead group 411. For example, one light bead group 411 may include at least three light beads arranged sequentially along a preset direction, namely a first light bead, a second light bead, and a third light bead: when the angle of deflection of the cutting plane S0 is small, only the first light bead located near a preset reference position is illuminated, to indicate a small deflection, essentially within a safe range; when the angle of deflection of the cutting plane S0 increases further, the first light bead is turned off, and only the second light bead located at an intermediate position is illuminated, to indicate that the angle of deflection is within a medium range, requiring the operator's attention for adjustment; and when the angle of deflection of the cutting plane S0 increases to a larger range, only the third light bead located on a side distal from the reference position is illuminated, and/or the third light bead is displayed in a flashing manner, to indicate a large angle of deflection, reminding the operator to adjust or stop work in a timely manner. It should be noted that the number of light beads, the arrangement method, and the illumination positions corresponding to different angles of deflection described above can be adjusted according to actual needs. For example, finer subdivisions of deflection ranges can also be represented by simultaneously illuminating two or more light beads at different positions, and these variations do not limit the scope of protection of the present disclosure.

The angle of deflection of the cutting plane S0 can also be reflected by the display colors of the light beads within the light bead group 411. For example, one light bead group 411 may include at least three light beads, namely a first light bead, a second light bead, and a third light bead: when the angle of deflection of the cutting plane S0 is small, the first light bead displays a first color, such as green, to indicate a small deflection, essentially within a safe range; when the angle of deflection of the cutting plane S0 increases further, the second light bead displays a second color, such as yellow, to indicate that the angle of deflection is within a medium range, requiring the operator's attention for adjustment; and when the angle of deflection of the cutting plane S0 increases to a larger range, the third light bead displays a third color, such as red, and/or is displayed in a flashing red manner, to indicate a large angle of deflection, reminding the operator to adjust or stop work in a timely manner. It should be noted that the first, second, and third colors are not limited to the examples of green, yellow, and red colors mentioned above. Any color combinations that are easily distinguishable from each other may be selected according to actual needs, and these combinations do not limit the scope of protection of the present disclosure.

In some embodiments of the present disclosure, the housing 1 includes a first housing 14 provided with a first handle 12 and a second housing 15 provided with a second handle 13, where the first housing 14 can rotate relative to the second housing 15 among at least three preset positions; the detection mechanism 5 is always configured to detect the deflection state of the cutting plane S0 relative to a reference plane and output a detection value; and the control mechanism 8 selects a corresponding light panel 41 and its preset area for graded indication based on the current position of the first housing 14 relative to the second housing 15.

In some embodiments, the preset area includes a first position; the first housing is in the first position when a section of the second handle extending along the length direction of the trimming tool is perpendicular to the cutting plane; the first housing can rotate relative to the second handle to the first position; and when in the first position, the control mechanism compares the detection signal output by the detection mechanism with preset thresholds and outputs a first signal and a second signal to the indicating mechanism, where operating states of the indicating mechanism corresponding to the first signal and the second signal are different.

For example, when the first housing 14 is in the first position relative to the second housing 15, the control mechanism 8 compares the detection value output by the detection mechanism 5 with a preset first threshold and/or a second threshold and/or a third threshold: when the angle of deflection corresponding to the detection value is small, for example, within approximately 5°, a single light bead is illuminated in a first preset area on the horizontal light panel 41 as a first signal; when the angle of deflection corresponding to the detection value increases further, for instance, within approximately 5° to 15°, two light beads are illuminated in the first preset area as a second signal; and when the angle of deflection corresponding to the detection value increases to a larger range, such as greater than approximately 15°, three light beads are illuminated in the first preset area, with the third light bead optionally illuminated with higher brightness or in a flashing manner as necessary, as a third signal.

For example, when the first housing 14 rotates to a second position relative to the second housing 15, the detection mechanism 5 continues to detect the deflection state of the cutting plane S0 relative to the reference plane and output a detection value, and the control mechanism 8 then selects a second preset area on the light panel 41 located on one side of the protective plate 11 for display: when the angle of deflection corresponding to the detection value is small (e.g., within approximately 5°), a single light bead is illuminated in the second preset area as a first signal; when the angle of deflection is within a medium range (e.g., approximately 5° to 15°), two light beads are illuminated in the second preset area as a second signal; and when the angle of deflection is large (e.g., greater than approximately 15°), three light beads are illuminated in the second preset area as a third signal.

Similarly, when the first housing 14 rotates to a third position relative to the second housing 15, the detection mechanism 5 continues to output a detection value reflecting the deflection state, and the control mechanism 8 selects a third preset area on the light panel 41 located on the other side of the protective plate 11 for graded display: when the angle of deflection corresponding to the detection value is small, a single light bead is illuminated in the third preset area as a first signal; when the angle of deflection is within a medium range, two light beads are illuminated in the third preset area as a second signal; and when the angle of deflection is large, three light beads are illuminated in the third preset area as a third signal.

Thus, the first housing can also rotate relative to the second handle to the second and/or third position, the first housing is in the second and/or third position when the section of the second handle extending along the length direction of the trimming tool is parallel or coplanar with the cutting plane, and the second position and the third position are arranged oppositely relative to the section of the second handle extending along the length direction of the trimming tool; when the first housing is in the second and/or third position, the detection value from the detection mechanism outputs the first signal and the second signal according to the second threshold; and the operating states of the indicating mechanism corresponding to the first signal and the second signal are different.

It should be noted that the values of approximately 5° and 15° mentioned above are only exemplary. The specific values of the first, second, and third thresholds, as well as the illumination combinations of the light beads in each preset area, can be adjusted according to actual product and safety requirements. As long as the graded indication of the degree of deflection is achieved within corresponding preset areas through the illumination intensity of “one light, two lights, three lights” based on the detection value from the detection mechanism 5 and at different preset positions of the first housing 14 relative to the second housing 15, it falls within the scope of protection of the present disclosure.

In some embodiments of the present disclosure, the light panels are provided with a plurality of light bead groups thereon; and the operating state of the indicating mechanism includes an illumination intensity and/or illumination position of the light bead groups, and/or a display color of the light bead groups.

In some embodiments of the present disclosure, the indicating mechanism includes at least one set of light panels; the light panels are provided with a plurality of light bead groups thereon; and the indicating mechanism indicates, according to a signal loaded by the sensing mechanism, an operating state through an illumination intensity and/or illumination position of the light bead groups, and/or a display color change of the light bead groups.

In this embodiment, by configuring the indicating mechanism to include at least one set of light panels, arranging a plurality of light bead groups on the light panels, and enabling the indicating mechanism to control the illumination intensity and/or illumination position and/or display color change of the light bead groups according to the signal loaded by the sensing mechanism, the deflection state of the cutting plane corresponding to the rotation of the second handle can be graded and visually represented within a limited light panel area. This enables more timely and accurate adjustment of the rotational angle of the second handle to restore the cutting plane to the desired posture.

In some embodiments, the indicating mechanism 4 includes at least three light panels 41 respectively disposed at different positions on the housing 1, where one of the light panels 41 is arranged approximately horizontally on the housing 1 along the length direction of the tool, while the other two light panels 41 are respectively disposed on the left and right sides of the housing 1, and may optionally be arranged substantially perpendicular to the horizontally arranged light panel 41. When the second handle 13 is in a grip posture relative to the housing 1 that corresponds to the horizontally arranged light panel 41, it is defined as the first position; when the second handle 13 rotates around the rotating shaft toward the left side of the housing 1 to a grip posture corresponding to the light panel 41 on the left side, it is defined as the second position; and when the second handle 13 rotates around the rotating shaft toward the right side of the housing 1 to a grip posture corresponding to the light panel 41 on the right side, it is defined as the third position.

In some embodiments of the present disclosure, the detection mechanism 5 includes, but is not limited to, an angle sensor capable of detecting angular changes, such as a gyroscope and a level gage. The angle sensor is installed on the housing 1 and has a fixed corresponding relationship with the installation posture of the cutting mechanism 2. It is configured to detect the angle of deflection of the cutting plane S0 relative to the reference plane and output a detection signal representing the deflection state. The control mechanism 8 performs analysis and grading of the degree of deflection based on the detection signal output by the angle sensor, thereby generating a display signal for driving the indicating mechanism 4 to operate. This enables the indicating mechanism 4 to intuitively indicate the deflection state of the cutting plane S0 relative to the reference plane.

In some embodiments of the present disclosure, the sensing mechanism 9 includes, but is not limited to, a Hall element or photoelectric sensor capable of detecting positional changes. For example, the Hall element is disposed at the rotating shaft between the housing 1 and the second handle 13. In some embodiments, the Hall element can cooperate with a magnetic component installed on the second handle 13 or the rotating shaft to detect the rotational position and/or rotational angle of the second handle 13 relative to the housing 1, and output a rotation signal indicating whether the second handle 13 is currently in the first, second, or third position. Based on the rotation signal output by the Hall element, the control mechanism 8 selects a light panel 41 and its preset display area corresponding to the current position of the second handle 13, and in combination with the detection signal from the detection mechanism 5, controls the light bead groups 411 on the corresponding light panel 41 to provide an indication.

In this embodiment, the sensing mechanism 9 is implemented in the form of a Hall sensor. The second handle 13 is rotatably connected to the housing 1 via a rotating shaft. The sensing mechanism (Hall element) of the second handle 13 is installed in the rotating shaft area, for example, fixed in a mounting cavity at one end of the rotating shaft, and cooperates with a magnetic steel disposed on the rotating shaft to sense the rotational angle of the second handle 13 around the rotating shaft. When the second handle 13 rotates about the deflection axis, the position of the magnetic steel relative to the Hall element changes, causing the Hall element to output an electrical signal corresponding to the rotational angle; the electrical signal is transmitted via a third lead wire to the control mechanism 8 inside the housing 1; and the control mechanism 8 collects and processes the electrical signal input via the third lead wire, analyzing the rotational direction of the second handle 13 relative to the reference position and the angle interval to which it belongs.

After obtaining the rotational direction and angle information of the second handle 13, the control mechanism 8 sends a driving signal via the second lead wire 7 to the display light panel 41 in the corresponding direction, causing the display light panel 41 in the area corresponding to the current rotational direction to produce a light display. For example, when the second handle 13 deflects leftward, the control mechanism 8 drives the display light panel 41 arranged in the left area to illuminate or change its display color; when the second handle 13 deflects rightward, the control mechanism 8 drives the display light panel 41 in the right area to illuminate. By adjusting the number, position, and/or display color of the illuminated light beads, an intuitive mapping of the rotational angle information onto the display light panel 41 is achieved. The operator can obtain the direction and degree of deflection of the cutting plane S0 relative to the reference plane simply by observing the light changes, thereby enabling timely adjustment of the tool's posture during operation.

In some cases, the Hall element can also be used to implement interlock control between the second handle 13 and the tool's start/stop. Specifically, the Hall element is configured to detect whether the second handle 13 is in a preset working position and/or is being properly held by the operator; the control mechanism 8 only allows a start command issued by a main trigger to be effective when it receives a valid rotation signal from the Hall element (e.g., indicating that the second handle 13 is in any one of the first, second, or third position and meets a preset hold condition). In this case, when the operator actuates the main trigger, the driving mechanism 3 can be driven to operate the cutting mechanism 2. When the Hall element detects that the second handle 13 is not in position, deviates from a safe position, or is released, the control mechanism 8 prevents the driving mechanism 3 from starting, and/or cuts off the driving of the driving mechanism 3 during tool operation, causing the cutting mechanism 2 to stop work.

Through the above interlock control setup, even if the main trigger is accidentally pressed, the trimming tool will not start if the second handle 13 is not in the specified working posture or is not correctly held, effectively reducing the risks of unintended startup, one-handed operation, or startup in abnormal postures, thereby enhancing the safety of use. At the same time, if the second handle 13 is released or accidentally deflects to a non-safe position during operation, the system can automatically stop or prevent continued driving, which helps meet higher-level safety regulation requirements.

Referring to FIGS. 1, 2, and 3, a trimming tool includes a housing 1, a cutting mechanism 2, a driving mechanism 3, an indicating mechanism 4, and a detection mechanism 5, where the housing 1 is provided with a protective plate 11, a first handle 12, and a second handle 13; both the cutting mechanism 2 and the driving mechanism 3 are disposed on the housing 1, the cutting mechanism 2 has a cutting plane S0, and the driving mechanism 3 is configured to drive the cutting mechanism 2 to operate; the indicating mechanism 4 is disposed on the protective plate 11, or the indicating mechanism 4 is disposed on the housing 1 between the first handle 12 and the second handle 13, and the indicating mechanism 4 is configured to indicate a deflection state of the cutting plane S0 relative to a reference plane; and the detection mechanism 5 is electrically connected to the indicating mechanism 4 and is configured to detect the deflection state of the cutting plane S0 relative to the reference plane and output a detection signal, where a straight line extending along a length direction of the cutting plane S0 and parallel to the reference plane serves as a deflection axis, and the deflection state is a state in which the cutting plane S0 is deflected relative to the reference plane about the deflection axis.

By arranging both the first handle 12 and the second handle 13 on the housing 1 and arranging the indicating mechanism 4 on the protective plate 11 and/or on an area of the housing 1 between the first handle 12 and the second handle 13, the position of the indicating mechanism 4 corresponds to an operator's conventional grip area, facilitating direct observation of indication information by the operator in a normal grip posture. Combined with the real-time detection of the deflection state of the cutting plane S0 relative to the reference plane by the detection mechanism 5, and by defining the straight line extending along the length direction of the cutting plane S0 and parallel to the reference plane as the deflection axis, the deflection state is clearly and uniformly defined as the state in which the cutting plane S0 is deflected relative to the reference plane about the deflection axis. This provides a clear and unified geometric description of the tool's posture. Consequently, on the one hand, the operator can intuitively know whether the cutting plane S0 deviates from the intended reference plane based on the display of the indicating mechanism 4, allowing timely adjustment of the operational posture and improving trimming accuracy and consistency; on the other hand, the clear definitions of the deflection axis and deflection state facilitate the application of consistent judgment criteria across different usage scenarios (such as near-horizontal or near-vertical trimming), reducing errors arising from differences in viewing angles and experience, while also maintaining the compact structure of the tool and enhancing the overall ergonomic performance and the safety of use.

In this embodiment, by arranging the protective plate, the first handle, and the second handle on the housing, and arranging the indicating mechanism on the protective plate or on the housing between the first handle and the second handle, the indicating mechanism is positioned at one side proximate to the cutting mechanism and within the forward field of view between the two handles. When operating the trimming tool with both hands while facing a to-be-trimmed object, the user does not need to turn around to look at the rear of the housing or lower his/her head to observe the handle end. That is to say, while observing the cutting plane and its trimming trajectory, the user can directly obtain information about the deflection state of the cutting plane relative to the reference plane. Combined with the definition of the deflection axis as the straight line extending along the length direction of the cutting plane and parallel to the reference plane, the deflection state displayed by the indicating mechanism corresponds to the actual spatial posture change of the blade rotating about this deflection axis. This makes the prompts for the direction and degree of deflection more intuitive and consistent, helping the user correct the posture of the trimming tool in a natural grip posture, improving the straightness and height consistency of trimming lines, and reducing operational inconvenience and safety hazards caused by frequently lowering the head or looking back. The positioning of the indicating mechanism described above is an overall layout formed based on the comprehensive consideration of human-tool field of view, grip posture, and the definition of the cutting plane's deflection axis, rather than a simple adaptive adjustment of arbitrarily installing display components at any position on the housing.

In this embodiment, when the indicating mechanism 4 is disposed on the protective plate 11, the protective plate 11 may employ different structural forms to adapt to various installation methods and protective requirements. The protective plate 11 may be a single-layer structure or a double-layer structure.

In some embodiments, the protective plate 11 is a single-layer structure, and the single-layer protective plate 11 may be integrally formed from a metal sheet or engineering plastic sheet, with a mounting surface for mounting the indicating mechanism 4 formed on a side facing the operator. The indicating mechanism 4 may be directly fixed onto the mounting surface by means such as screw connection, snap-fit connection, or adhesion. The lead wires connected to the indicating mechanism 4 are routed through wire holes or openings formed in the protective plate 11 to the interior of the housing 1. The single-layer protective plate 11 features a simple structure, low manufacturing cost, and easy processing and assembly, making it suitable for situations where the mounting space for the indicating mechanism 4 is relatively limited.

In other embodiments, the protective plate 11 is a double-layer structure. The double-layer protective plate 11 includes a first protective layer 111 and a second protective layer 112 disposed sequentially along a front-to-rear direction of the trimming tool, where the first protective layer 111 faces the cutting mechanism 2, the second protective layer 112 faces the operator, and the first protective layer 111 and the second protective layer 112 are spaced apart, forming an accommodating space therebetween for accommodating the indicating mechanism 4. The indicating mechanism 4 is at least partially disposed inside the accommodating space, and a display surface S3 of the indicating mechanism 4 communicates with the outside through a window penetrating the second protective layer 112, facilitating observation by the operator; and electrical connection leads of the indicating mechanism 4 are wired inside the accommodating space and extend to the interior of the housing 1. The double-layer protective plate 11, on the one hand, reserves a mounting space for the indicating mechanism 4 without significantly increasing the overall outline dimensions of the trimming tool; on the other hand, it uses the first protective layer 111 to block debris splashed during the cutting process and utilizes the double-layer structure to enclose and protect the indicating mechanism 4 and leads thereof, thereby enhancing the protective performance and installation stability of the indicating mechanism 4.

It should be noted that the second handle 13 is fixedly connected to the housing 1. That is to say, the installation posture of the second handle 13 relative to the housing 1 is fixed and does not have the function of rotating about a rotating shaft. By adopting a fixed connection structure, the mechanical cooperation relationship between the handle and the housing 1 can be simplified, reducing the number of rotating mechanisms, limit structures, and corresponding sensing assemblies. This helps lower component costs and assembly difficulty while enhancing the structural strength and long-term reliability of the entire tool. At the same time, for conventional trimming conditions, it provides a stable and consistent grip posture, allowing the operator to develop fixed operating habits after becoming familiar with the tool, further improving operational stability. It should be noted that this embodiment is only an exemplary configuration of a fixed connection between the handle and the housing 1 and does not exclude the possibility of using a rotatable connection for the second handle 13 in other embodiments to accommodate more grip postures.

In some embodiments, the indicating mechanism is disposed on the protective plate, one end of the first lead wire is electrically connected to the detection mechanism, and the first lead wire is configured to transmit a deflection signal acquired by the detection mechanism regarding the cutting plane relative to the reference plane; the control mechanism is electrically connected to the other end of the first lead wire and is configured to output a display signal based on the deflection signal; one end of the second lead wire is electrically connected to the control mechanism, and the other end of the second lead wire extends to a middle area of the protective plate to be electrically connected to the indicating mechanism; or, the other end of the second lead wire extends to a side area of the protective plate to be electrically connected to the indicating mechanism, and the second lead wire is configured to load the display signal onto the indicating mechanism.

In some embodiments of the present disclosure, based on the foregoing solution, the first handle is disposed at one end of the housing proximate to the cutting mechanism and the protective plate; the second handle is disposed at the other end of the housing distal from the cutting mechanism and the protective plate; and a first included angle is formed between a display surface of the indicating mechanism and the cutting plane, where the first included angle is greater than or equal to 20° and less than 90°.

In some cases, in this embodiment, as an example, the indicating mechanism 4 includes only one light panel 41. The light panel 41 is disposed on the protective plate 11, optionally positioned where it is easily observable by the operator when normally holding the first handle 12 and the second handle 13. Along the length direction of the light panel 41, a first light bead, a second light bead, and a third light bead are arranged in sequence, collectively forming a first preset area for indicating the deflection state of the cutting plane S0. The detection mechanism 5 is configured to detect the angle of deflection of the cutting plane S0 relative to the reference plane and output a detection value, and the control mechanism 8 controls the illumination combination of the three light beads within the first preset area based on the detection value, thereby achieving graded indication of different degrees of deflection on the same light panel 41.

In some embodiments, an included angle of inclination is formed between the reference plane perpendicular to the cutting plane and a section extending along a length direction of the first handle, where the included angle of inclination is in a range of 0° to 15°. In some embodiments of the present disclosure, based on the foregoing solution, a preset plane is defined between a bottom end of the indicating mechanism proximate to the housing and a top end of a gripping portion of the first handle, a second included angle is formed between the preset plane and the cutting plane, and the second included angle is between 0° and 90°.

In some embodiments of the present disclosure, based on the foregoing solution, a third included angle is formed between a plane where a line connecting a top end of the first handle and a top end of the protective plate lies and a horizontal plane where the top end of the first handle lies, where the third included angle is between 10° and 45°.

In some embodiments of the present disclosure, based on the foregoing solution, a fourth included angle is formed between a plane where a line connecting a vertex on a side portion of the first handle and a vertex on a side portion of the protective plate lies and the cutting plane, where the fourth included angle is between 0° and 35°;

In some embodiments of the present disclosure, based on the foregoing solution, on a projection plane perpendicular to the cutting plane, a widest distance of a projection of the first handle is a first distance, and a widest distance of a projection of the indicating mechanism is a second distance, where the first distance ranges from 190 mm to 250 mm, the second distance ranges from 100 mm to 250 mm, and a ratio of the first distance to the second distance is between 1:1 and 1:2.5.

In some embodiments, one or more boundary values can be preset for the angle of deflection to divide the angle of deflection of the cutting plane S0 into three intervals: small deflection, medium deflection, and large deflection. For example, when the angle of deflection corresponding to the detection value from the detection mechanism 5 is small, such as within approximately 5°, only the first light bead is illuminated, and/or illuminated with lower brightness, serving as a first signal to indicate that the cutting plane S0 is essentially within a safe range; when the angle of deflection increases further, for example, within a medium range of approximately 5° to 15°, both the first and second light beads are illuminated simultaneously, and/or the brightness of the second light bead is higher than that of the first light bead, serving as a second signal to indicate that the angle of deflection has significantly increased, requiring the operator's attention for adjustment; and when the angle of deflection increases to a larger range, such as greater than approximately 15°, the first, second, and third light beads are all illuminated together, and/or the third light bead is illuminated with higher brightness or in a flashing manner, serving as a third signal to indicate a large angle of deflection, reminding the operator to adjust or stop work in a timely manner. It should be noted that the values of approximately 5° and 15° mentioned above are exemplary settings. In practical applications, the boundary angles and corresponding light bead illumination combinations can be adjusted based on the structural dimensions, usage scenarios, and safety requirements of different tools. As long as graded feedback on the angle of deflection is achieved through the illumination intensity of the light bead groups 411 on the same light panel 41, it falls within the scope of protection of the present disclosure.

It should be noted that the descriptions of the number of light panels 41 and their arrangement positions in the above embodiments are for illustrative purposes only and do not limit the present disclosure. For example, in some embodiments, the indicating mechanism 4 may include only one light panel 41, which is horizontally disposed on the protective plate 11 for indicating the deflection state of the cutting plane S0.

It should be noted that this embodiment may be consistent with Embodiment I in some respects, which will not be elaborated herein.

Referring to FIGS. 1 to 3, a trimming tool includes a housing 1, a cutting mechanism 2, a driving mechanism 3, an indicating mechanism 4, a detection mechanism 5, and a control mechanism 8, where the housing 1 is provided with a protective plate 11 thereon; both the cutting mechanism 2 and the driving mechanism 3 are installed inside or on the housing 1, the cutting mechanism 2 has a cutting plane S0, and the driving mechanism 3 is configured to drive the cutting mechanism 2 to operate, so as to form the cutting plane S0 for trimming; the indicating mechanism 4 is disposed on the protective plate 11 or on the housing 1 between the protective plate 11 and the driving mechanism 3, and is configured to indicate a deflection state of the cutting plane S0 relative to a reference plane; the detection mechanism 5 is installed on the housing 1 and is configured to detect the deflection state of the cutting plane S0 relative to the reference plane and output a detection signal to the control mechanism 8; the control mechanism 8 is electrically connected to the detection mechanism 5 and the indicating mechanism 4, and compares the detection signal with preset thresholds, outputs a first signal and a second signal, and drives the indicating mechanism 4 to provide an indication in a corresponding preset area based on the detection signal, where operating states of the indicating mechanism 4 corresponding to the first signal and the second signal are different from each other; and a straight line extending along a length direction of the cutting plane S0 and parallel to the reference plane serves as a deflection axis L0, and the deflection state refers to a state in which the cutting plane S0 deflects relative to the reference plane about the deflection axis L0.

In this embodiment, during use, the operator holds the housing and activates the driving mechanism, which drives the cutting mechanism to operate, forming the cutting action; when the cutting plane deflects relative to the reference plane due to factors such as working posture, branch forces, or wrist movement, the cutting plane rotates about the deflection axis, which is defined as “the straight line extending along the length direction of the cutting plane and parallel to the reference plane”, resulting in the deflection state; the detection mechanism detects the deflection state in real time and outputs a detection signal; the control mechanism compares the detection signal with thresholds, generates a first signal or a second signal, and further controls the indicating mechanism to provide an indication in its corresponding preset area, which causes the operating states of the indicating mechanism corresponding to the first signal and the second signal to differ (e.g., different illumination states, indication positions, or display modes), thereby guiding the operator to adjust the grip angle or working direction promptly, bringing the cutting plane back within a target deflection range.

With the configuration described above, real-time and intuitive graded prompts for the deflection state of the cutting plane relative to the reference plane can be provided, reducing the operator's reliance on subjective judgment of the cutting posture. This facilitates quick identification of whether deflection exceeds limits under different working directions and viewing angles, enabling timely correction, thereby improving cutting safety and operational consistency. At the same time, by positioning the indicating mechanism on the protective plate or on an area of the housing between the protective plate and the driving mechanism, both visibility and protection performance can be ensured, making the indication information easier to observe and less susceptible to obstruction by debris or impact. This helps reduce operational errors, lower the risks of jamming or deviated cuts, and enhances usability and ergonomic performance for both novice users and working scenarios involving complex postures, mitigating the risks of mis-trimming or repeated trimming due to inaccurate posture judgment.

In this embodiment, the control mechanism 8 is pre-configured with multiple preset thresholds, including a first threshold, and/or a second threshold, and/or a third threshold. The control mechanism 8 calculates the angle of deflection of the cutting plane S0 relative to the reference plane based on the detection signal output by the detection mechanism 5, and then compares the angle of deflection with the first threshold, and/or the second threshold, and/or the third threshold to determine a threshold interval to which the current deflection state belongs. The first, second, and third thresholds correspond spatially to different preset areas on the indicating mechanism 4. For example, they respectively correspond to a first preset area located in the middle portion, second preset areas located on both sides of the middle portion, and a third preset area located at the outermost side. This establishes a one-to-one correspondence between numerical thresholds and visual display positions. The numerical values of the thresholds can be set to be the same or different. For example, in a symmetrical arrangement, the first, second, and third thresholds can be set to the same absolute value, but the direction and degree of deflection are distinguished through different display areas.

Specifically, in an exemplary embodiment, the angle of deflection of the cutting plane S0 can be divided into three intervals: small deflection, medium deflection, and large deflection, by presetting the first, second, and third thresholds. For example, the first threshold can be illustratively set to approximately 5°, the second threshold can be illustratively set to approximately 15°, and the third threshold can be used to define the upper limit or alarm threshold for the large deflection interval.

When the angle of deflection corresponding to the detection value from the detection mechanism 5 is small, for example, when the absolute value of the angle of deflection is less than or equal to the first threshold (e.g., within approximately 5°), only the first light bead is illuminated, and/or illuminated with lower brightness, serving as a first signal corresponding to a first operating state of the indicating mechanism 4 to indicate that the cutting plane S0 is essentially within a safe range; when the angle of deflection increases further and falls between the first threshold and the second threshold, for example, within a medium range of approximately 5° to 15°, both the first and second light beads are illuminated simultaneously, and/or the brightness of the second light bead is higher than that of the first light bead, serving as a second signal corresponding to a second operating state of the indicating mechanism 4 to indicate that the angle of deflection has significantly increased, requiring the operator's attention for adjustment; and when the angle of deflection continues to increase and exceeds the second threshold, for example, when the absolute value of the angle of deflection is greater than approximately 15° and less than or equal to the third threshold, the first, second, and third light beads are all illuminated together, and/or the third light bead is illuminated with higher brightness or in a flashing manner, serving as a third signal corresponding to a third operating state of the indicating mechanism 4 to indicate a large angle of deflection, reminding the operator to adjust or stop work in a timely manner.

In some embodiments, the first, second, and third thresholds can be set with increasing numerical values. Alternatively, they may be set to the same or different numerical values based on the spatial positional correspondence of different display areas and/or different light bead groups 411 on the light panel 41, provided that each threshold has a clear correspondence between its numerical value interval and the corresponding display area, for example, the first threshold corresponds to the middle area of the light panel 41, the second threshold corresponds to the areas on both sides of the middle portion, and the third threshold corresponds to the outermost area. It should be noted that the values of approximately 5° and 15° mentioned above are exemplary settings. In practical applications, the specific numerical values of the thresholds and the corresponding light bead illumination combinations is able to be adjusted according to the structural dimensions, usage scenarios, and safety requirements of different tools. As long as graded feedback on the angle of deflection is achieved through changes in the illumination intensity and/or illumination position, and/or the display color of the light beads within the light bead groups 411 on the same light panel 41, it falls within the scope of protection of the present disclosure.

In an optional embodiment, the indicating mechanism 4 includes at least one light panel 41 and a plurality of light beads disposed on the light panel 41. When outputting the first signal and the second signal, the control mechanism 8 causes the operating state of the indicating mechanism 4 to change, and the operating state corresponds to changes in the illumination intensity and/or illumination position of the light beads, and/or changes in the display color of the light beads. Specifically, changes can be made to the illumination intensity of the light beads (e.g., constant illumination, turning off, or flashing at different frequencies), the position of the illuminated light beads on the indicating mechanism 4 (e.g., illuminating only light beads near the middle portion, sequentially expanding illumination of light beads toward both sides, or illuminating only light beads near one side), and/or the display color of the light beads (e.g., green indicating the angle of deflection is within a target range, yellow indicating the angle of deflection is approaching the threshold, red indicating the angle of deflection exceeds the threshold), thereby visually distinguishing different deflection states. When the angle of deflection falls within the interval bounded by the first threshold, the control mechanism 8 can drive the light beads in the first preset area to operate in a first operating state; and when the angle of deflection falls within the interval bounded by the second or third threshold, the control mechanism 8 can drive the light beads in the second or third preset area to operate in another operating state. Through changes in the illumination intensity, illumination position, and/or display color of the light beads, the operator is provided with clear feedback on the direction and degree of deflection of the cutting plane S0 relative to the reference plane.

In some embodiments, when the indicating mechanism 4 is installed on the protective plate 11, the protective plate 11 may employ different structural forms to adapt to various installation methods and protective requirements. The protective plate 11 may be a single-layer structure or a double-layer structure.

In some embodiments, the protective plate 11 is a single-layer structure, and the single-layer protective plate 11 may be integrally formed from a metal sheet or engineering plastic sheet, with a mounting surface for mounting the indicating mechanism 4 formed on a side facing the operator. The indicating mechanism 4 may be directly fixed onto the mounting surface by means such as screw connection, snap-fit connection, or adhesion. The lead wires connected to the indicating mechanism 4 are routed through wire holes or openings formed in the protective plate 11 to the interior of the housing 1. The single-layer protective plate 11 features a simple structure, low manufacturing cost, and easy processing and assembly, making it suitable for situations where the mounting space for the indicating mechanism 4 is relatively limited.

In other embodiments, the protective plate 11 is a double-layer structure. The double-layer protective plate 11 includes a first protective layer 111 and a second protective layer 112 disposed sequentially along a front-to-rear direction of the trimming tool, where the first protective layer 111 faces the cutting mechanism 2, the second protective layer 112 faces the operator, and the first protective layer 111 and the second protective layer 112 are spaced apart, forming an accommodating space therebetween for accommodating the indicating mechanism 4. The indicating mechanism 4 is at least partially disposed inside the accommodating space, and a display surface S3 of the indicating mechanism 4 communicates with the outside through a window penetrating the second protective layer 112, facilitating observation by the operator; and electrical connection leads of the indicating mechanism 4 are wired inside the accommodating space and extend to the interior of the housing 1. The double-layer protective plate 11, on the one hand, reserves a mounting space for the indicating mechanism 4 without significantly increasing the overall outline dimensions of the trimming tool; on the other hand, it uses the first protective layer 111 to block debris splashed during the cutting process and utilizes the double-layer structure to enclose and protect the indicating mechanism 4 and leads thereof, thereby enhancing the protective performance and installation stability of the indicating mechanism 4.

It should be noted that in this embodiment, the indicating mechanism 4 is disposed on the protective plate 11 or on the housing 1 between the first handle 12 and the second handle 13. However, in this embodiment, the indicating mechanism 4 can not only be set on the protective plate 11 but also on an area of the housing 1 corresponding to the first handle 12 and the second handle 13. This further optimizes the placement of the indicating mechanism 4 relative to the operator's grip area while meeting different structural design and appearance design requirements.

In some embodiments of the present disclosure, the indicating mechanism 4 includes at least one light panel 41 provided with at least three light beads thereon. The trimming tool further includes a detection mechanism 5 and a control mechanism 8, where the detection mechanism 5 is disposed on the housing 1 and configured to detect a deflection state of the cutting plane S0 relative to a reference plane and output a detection signal; and the control mechanism 8 controls, based on a rotation signal, the indicating mechanism 4 to provide an indication in its corresponding area according to rotation information, and further controls the indicating mechanism 4 to cause, based on the detection signal, changes in the illumination intensity and/or illumination position of the at least three light beads, and/or in the display color of the light beads.

Specifically, the at least three light beads may be a first light bead, a second light bead, and a third light bead (taking three light beads as an example): when the angle of deflection of the cutting plane S0 is small, only the first light bead is illuminated, and/or illuminated with lower brightness, to indicate a small deflection, essentially within a safe range; when the angle of deflection of the cutting plane S0 increases further, both the first and second light beads are illuminated simultaneously, and/or the brightness of the second light bead is higher than that of the first light bead, to indicate that the angle of deflection is within a medium range, requiring the operator's attention for adjustment; and when the angle of deflection of the cutting plane S0 increases to a larger range, the first, second, and third light beads are all illuminated together, and/or the third light bead is illuminated with higher brightness or in a flashing manner, to indicate a large angle of deflection approaching or even reaching an upper limit of an allowable range, reminding the operator to adjust or stop work in a timely manner. It should be noted that the number of light beads, the illumination sequence, and the brightness variation method described above can be adjusted according to actual needs and do not limit the scope of protection of the present disclosure.

As another example, the angle of deflection of the cutting plane S0 can be reflected by the illumination position of different light beads among the at least three light beads. For example, when the angle of deflection of the cutting plane S0 is small, only the first light bead located near a preset reference position is illuminated, to indicate a small deflection, essentially within a safe range; when the angle of deflection of the cutting plane S0 increases further, the first light bead is turned off, and only the second light bead located at an intermediate position is illuminated, to indicate that the angle of deflection is within a medium range, requiring the operator's attention for adjustment; and when the angle of deflection of the cutting plane S0 increases to a larger range, only the third light bead located on a side distal from the reference position is illuminated, and/or the third light bead is displayed in a flashing manner, to indicate a large angle of deflection, reminding the operator to adjust or stop work in a timely manner.

It should be noted that the number of light beads, the arrangement method, and the illumination positions corresponding to different angles of deflection described above can be adjusted according to actual needs. For example, finer subdivisions of deflection ranges can also be represented by simultaneously illuminating two or more light beads at different positions, and these variations do not limit the scope of protection of the present disclosure.

As another example, the angle of deflection of the cutting plane S0 can be reflected by the display colors of the at least three light beads. For example, when the angle of deflection of the cutting plane S0 is small, the first light bead displays a first color, such as green, to indicate a small deflection, essentially within a safe range; when the angle of deflection of the cutting plane S0 increases further, the second light bead displays a second color, such as yellow, to indicate that the angle of deflection is within a medium range, requiring the operator's attention for adjustment; and when the angle of deflection of the cutting plane S0 increases to a larger range, the third light bead displays a third color, such as red, and/or is displayed in a flashing red manner, to indicate a large angle of deflection, reminding the operator to adjust or stop work in a timely manner. It should be noted that the first, second, and third colors are not limited to the examples of green, yellow, and red colors mentioned above. Any color combinations that are easily distinguishable from each other may be selected according to actual needs, and these combinations do not limit the scope of protection of the present disclosure.

In the above embodiment, the control mechanism 8 includes a first control board 81 and a second control board 82, where the first control board 81 is disposed at a position on the housing 1 corresponding to the second handle 13 and is provided with buttons such as a speed control switch for adjusting operating parameters of the driving mechanism 3 and an indicating mechanism control switch for setting an operating mode of the indicating mechanism 4; the first control board 81 is configured to collect the operator's input signals on the second handle 13; the second control board 82 is disposed inside the housing 1 between the first handle 12 and the second handle 13 and is electrically connected to the driving mechanism 3, the indicating mechanism 4, and a battery pack; and the second control board 82 is configured to process signals from the first control board 81 and the detection mechanism 5 in a centralized manner and output control signals.

When the detection mechanism 5 is disposed on the second handle 13, one end of the first lead wire 6 is electrically connected to the detection mechanism 5, and the other end thereof is electrically connected to the second control board 82; the first lead wire 6 is configured to transmit the detection signal acquired by the detection mechanism 5 to the second control board 82; the second control board 82 performs filtering, calculation, and threshold determination on the detection signal transmitted via the first lead wire 6 to obtain the deflection state of the cutting plane S0 relative to the first reference plane S1 and/or the second reference plane S2, and based on preset decision rules, generates a display signal for driving the indicating mechanism 4, which is output to the indicating mechanism 4 via the second lead wire 7, causing the light panels 41 and light bead groups 411 disposed on the protective plate 11 and/or on the housing 1 between the protective plate 11 and the driving mechanism 3 to display the direction and/or degree of deflection of the cutting plane S0.

The position corresponding to the first control board 81 is provided with operating buttons, through which the operator triggers the first control board 81 to output angle detection commands and/or operating mode switching commands to the second control board 82; the second control board 82, in response to the commands from the first control board 81, processes the detection signals collected by the detection mechanism 5 accordingly, and then drives the indicating mechanism 4 via the second lead wire 7 to update the display content, thereby realizing the detection, determination, and prompting of the angle of deflection of the cutting plane S0.

As an example, in some embodiments, a display terminal can also be arranged on the housing 1 and is electrically connected to the second control board 82. The operator issues angle detection commands and/or operating mode switching commands through touch or press operations on the display terminal, and then the second control board 82 processes the output signals from the detection mechanism 5 and drives the indicating mechanism 4 accordingly. The functional effect is similar to the control process achieved through button operations on the first control board 81.

The trimming tool further includes a third lead wire 71 configured to electrically connect adjacent light panels 41 for transmitting and distributing display signals among a plurality of light panels 41. The trimming tool further includes a fourth lead wire 72 configured to electrically connect the second control board 82 to a battery pack, providing operating power to the second control board 82 and the indicating mechanism 4 connected thereto

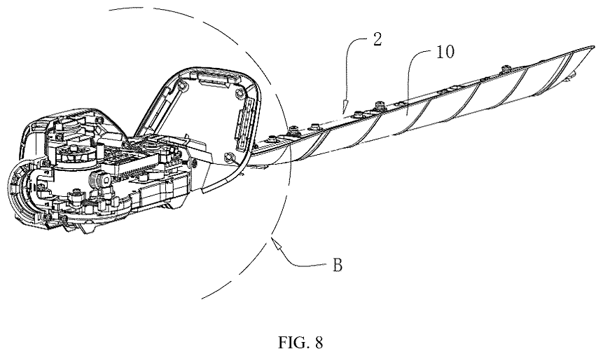

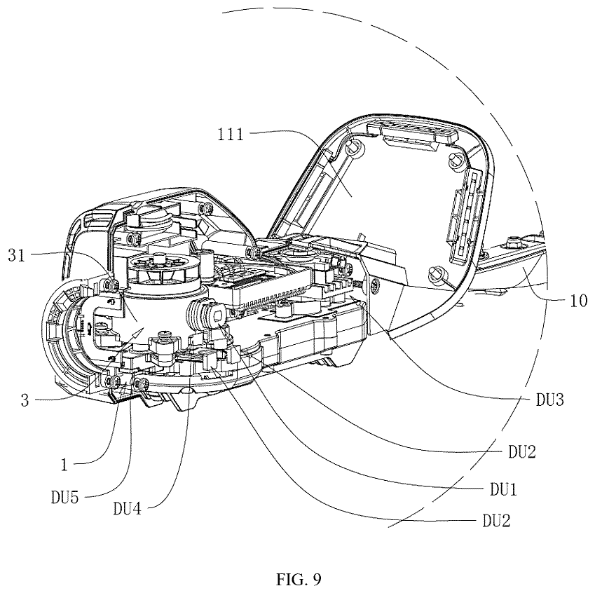

In some embodiments, referring to FIGS. 8 and 9, the trimming tool further includes a first damping unit DU1 having one end connected to the driving mechanism 3 and the other end oriented in a horizontal direction toward an inner wall of the housing 1 corresponding to the driving mechanism 3, and in a static state, a gap is reserved between the first damping unit DU1 and the inner wall of the housing 1, so that when vibration occurs in the horizontal direction in the driving mechanism 3, the first damping unit DU1 can movably abut against the inner wall of the housing 1 in the horizontal direction; alternatively, the first damping unit DU1 may have one end connected to the inner wall of the housing 1 and the other end oriented in the horizontal direction toward the driving mechanism 3, and in a static state, a gap is reserved between the first damping unit DU1 and the driving mechanism 3, so that when vibration occurs in the horizontal direction in the driving mechanism 3, the first damping unit DU1 can movably abut against the driving mechanism 3 in the horizontal direction, where the horizontal direction is defined as a direction extending along a width direction of the first handle 12 when the trimming tool is in a normal use posture.

In some embodiments, the first damping unit DU1 may also be in an abutting state with the inner wall of the housing 1 within an allowable range of assembly tolerances, and the first damping unit DU1 buffers and limits a displacement of the driving mechanism 3 in the horizontal direction through elastic deformation thereof.

As an example, the number of the first damping units DU1 is two, disposed on the left and right sides of the driving mechanism 3 along a length direction of the cutting mechanism 2, respectively. For example, two first damping units DU1 are disposed on left and right sides of a housing of a driving motor 31 to provide symmetrical lateral damping support for the driving mechanism 3. In other embodiments, the number of the first damping units DU1 may also be one or more, with the specific number and positions designed according to the structural dimensions and vibration characteristics of the driving mechanism 3. By allowing the first damping unit DU1 to either have a gap reserved from the inner wall of the housing 1 or directly abut against the housing 1 under certain assembly conditions, the first damping unit DU1 can provide flexible yielding space during the initial stage of vibration and form elastic limit support when a displacement reaches a certain magnitude, thereby helping balance damping performance and structural stability under different working conditions. By symmetrically arranging two first damping units DU1 on the left and right sides of the driving motor 31, the support moment distribution of the driving mechanism 3 in the horizontal direction becomes more uniform. This effectively suppresses sway and torsion of the motor assembly, further reduces vibration and noise transmission, and enhances the overall tool's operational smoothness and the user's grip comfort.

As an embodiment, the first damping unit DU1 is made of a flexible material. For example, the first damping unit DU1 incorporates structural hollowing to enhance elastic feedback given a certain material flexibility.

In some embodiments, referring to FIGS. 8 and 9, the trimming tool further includes a second damping unit DU2 disposed between the housing 1 and the driving mechanism 3 and configured to mitigate an impact of movement of the driving mechanism 3 on the housing 1.

As an example, along a length direction of the first handle 12, a thickness of the second damping unit DU2 is between 2.9 mm and 3.5 mm.

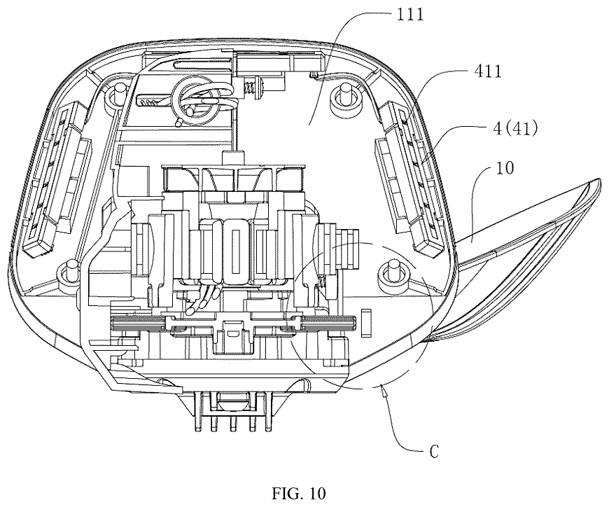

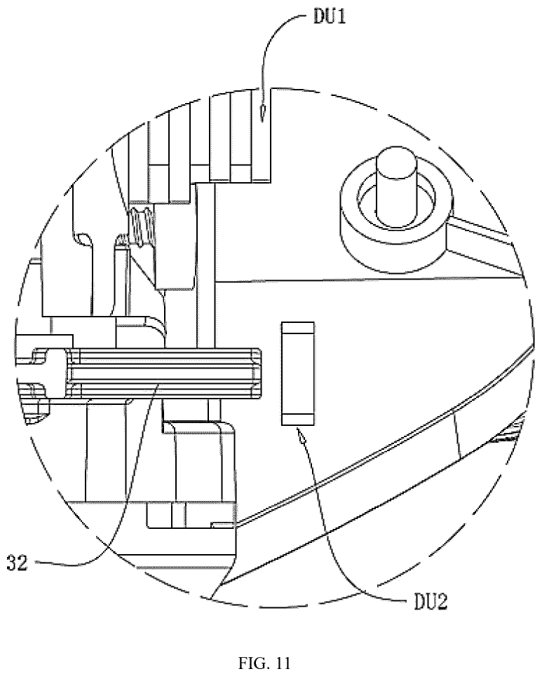

As another example, referring to FIGS. 8, 9, 10, and 11, the driving mechanism 3 includes a driving motor 31 and a driving seat 32, where the driving seat 32 is installed in a cavity of the housing 1 and, along the length direction of the first handle 12, a distance between mutually facing sides of the driving seat 32 and the second damping unit DU2 is between 2 mm and 5 mm.

By arranging the second damping unit DU2 between the housing 1 and the driving mechanism 3, limiting the thickness of the second damping unit DU2 to between 2.9 mm and 3.5 mm, and limiting the distance between the mutually facing sides of the second damping unit DU2 and the driving seat 32 to between 2 mm and 5 mm, the second damping unit DU2, after assembly, operates within a suitable preload and deformation range. This facilitates effective absorption and attenuation of vibrations and impacts generated by the driving motor 31 during operation, reducing the amplitude of vibration transmission to the housing 1, decreasing shaking felt on the first handle 12 and the second handle 13, and enhancing the operator's grip comfort. At the same time, it alleviates fatigue damage to connection portions, internal circuit boards, and fasteners of the housing 1 caused by long-term vibration, thereby improving the structural reliability and service life of the trimming tool.

As another example, referring to FIGS. 8 and 9, the trimming tool further includes a third damping unit DU3 disposed between the housing 1 and the cutting mechanism 2. For example, the third damping unit DU3 may be a silicone damping pad.

By arranging the third damping unit DU3 between the housing 1 and the cutting mechanism 2, such as a silicone damping pad, instantaneous impacts and high-frequency vibrations generated when the cutting mechanism 2 contacts a workpiece, cuts branches, or jams are buffered and filtered before reaching the housing 1. This helps reduce disturbances to the overall tool posture caused by blade chatter or bouncing, improves the stability and neatness of the cutting plane S0, and lowers cutting noise. The silicone material possesses good elasticity and resilience, maintaining stable damping performance under repeated compression conditions and offering certain resistance to aging and temperature, thereby contributing to the long-term stability of the damping effect.

As another example, referring to FIGS. 8 and 9, the trimming tool further includes a fourth damping unit DU4 disposed between the housing 1 and the driving mechanism 3. The fourth damping unit DU4 is configured to mitigate the impact of movement of the driving mechanism 3 on the housing 1. For example, the fourth damping unit DU4 may be a soft rubber damping pad.

By arranging the fourth damping unit DU4 between the housing 1 and the driving mechanism 3 and using a soft rubber damping pad, minor vibrations and medium-to-low frequency vibrations generated during normal operation of the driving mechanism 3 are first absorbed and dissipated by the soft rubber damping pad. This further reduces the transmission of vibrations to the housing 1, handles, and the indicating mechanism 4. The relatively low hardness of soft rubber allows for a larger deformation stroke without significantly increasing structural stiffness, providing smooth transition and cushioning during the start/stop and speed changes of the driving mechanism 3, consequently reducing unusual noises and shocks while improving the smoothness and quietness of the entire tool's operation.

As another example, referring to FIGS. 8 and 9, the trimming tool further includes a fifth damping unit DU5 disposed between the housing 1 and the driving mechanism 3. The fifth damping unit DU5 is configured to mitigate the impact of movement of the driving mechanism 3 on the housing 1. For example, the fifth damping unit DU5 may be a hard rubber damping pad. By arranging the fifth damping unit DU5 between the housing 1 and the driving mechanism 3 and using a hard rubber damping pad, the fifth damping unit DU5 not only offers a certain level of damping capability but also provides higher support stiffness and positioning accuracy for the driving mechanism 3. Under conditions such as significant external impact, dropping, or high-load cutting, this helps limit displacement and deflection of the driving mechanism 3, preventing excessive swinging or collision of the driving motor 31 or a reduction mechanism relative to the housing 1. Compared to a completely rigid connection, the hard rubber damping pad can still absorb some high-frequency impacts. Thus, while ensuring structural strength and installation stability, it balances damping and protection effects, further enhancing the reliability of the entire tool under complex working conditions.

In the embodiments of the present disclosure, the third damping unit DU3 and the fifth damping unit DU5 are mainly configured to counteract vibrations generated by the driving mechanism 3 in a vertical direction, while the fourth damping unit DU4 is configured to further reduce vibration impacts of the driving mechanism 3 in a second direction. Specifically, the first direction can be understood as a direction aligned with a length direction of a blade in the tool's cross-section, and the second direction is perpendicular to the first direction within the cross-section. Vibrations of the driving mechanism 3 in the aforementioned directions are restrained by the third damping unit DU3, the fourth damping unit DU4, and the fifth damping unit DU5, confining the vibration amplitude of the driving mechanism 3 within preset ranges across multiple spatial degrees of freedom. By arranging the damping units at different positions between the tool core and the left and right housings, an isolated contact relationship is structurally formed between the tool core and the housing 1, creating an overall state similar to suspended installation. Combined with the design of damping structures made from soft rubber with varying hardness levels and the frequency response characteristics of the soft rubber, components with similar inherent frequencies can be effectively isolated, significantly weakening vibration transmission between the tool core and the housing, reducing noise, and improving the smoothness of the entire tool's operation.

It can be understood that different damping units employ differentiated elastic designs. For example, the elastic coefficients of the second damping unit DU2 and the fifth damping unit DU5 are smaller than those of the first damping unit DU1, the third damping unit DU3, and the fourth damping unit DU4 to provide softer support in corresponding directions for absorbing larger vibration displacements. Although the material of the third damping unit DU3 may be the same as that of the first damping unit DU1 and the fourth damping unit DU4, by incorporating structurally hollowed-out slots or openings, the elastic coefficient of the overall third damping unit DU3 is made higher than those of the first damping unit DU1 and the fourth damping unit DU4. This provides support with relatively higher stiffness and limiting capability in the vertical direction, facilitating precise control of the vibration amplitude of the blade assembly and transmission mechanism in the vertical direction, and achieving graded isolation and optimized suppression of vibrations in different directions.

In some embodiments, referring to FIG. 8, the trimming tool further includes a debris shield 10. The debris shield 10 is disposed on the housing 1, positioned outside the cutting mechanism 2, and extends at least partially along the length direction of the cutting mechanism 2 on one side of the cutting plane S0. This allows an edge of the debris shield 10 near the cutting mechanism 2 to block and guide debris generated during cutting. In a cross-section containing the normal direction of the cutting plane S0, the debris shield 10 is arranged in an arc shape, with a side facing the cutting mechanism 2 being concave and having a certain curvature. When the debris shield 10 is installed on the trimming tool, the curvature at one end of the debris shield 10 distal from the housing is greater than the curvature at the other end of the debris shield 10 proximate to the housing, and the curvature decreases smoothly from the end of the debris shield 10 distal from the housing to the other end thereof proximate to the housing. By forming the side of the debris shield 10 facing the cutting mechanism 2 as a concave surface with a certain curvature, on the one hand, when debris is flung out by the cutting mechanism 2, the debris shield 10 can envelop and deflect the trajectory of the debris, guiding it to scatter away from the housing 1, the protective plate 11, and the areas where the gripping portion 121 of the first handle 12 and the second handle 13 are located, thereby reducing the risk of debris directly impacting the operator and his/her gripping areas; on the other hand, compared to a flat shield, the arc-shaped structure helps reduce the rebound and splatter range of debris, causing more debris to slide down along the concave surface to the area below or to lateral areas distal from the operating area, thereby aiding in maintaining relative cleanliness of the housing 1 and surrounding areas, and enhancing operational safety and comfort.

Referring to FIGS. 1-3, a trimming tool includes a housing 1, a cutting mechanism 2, an indicating mechanism 4, and a control mechanism 8, where the housing 1 includes a first housing 141 provided with a first handle 12 and a second housing 151 provided with a second handle 13, the first housing 141 being movable relative to the second housing 151 between a first position and a second position; the cutting mechanism 2 is disposed on the housing 1 and has a cutting plane S0; the indicating mechanism 4 is disposed on the housing 1 and configured to indicate a deflection state of the cutting plane S0 relative to a reference plane; and the control mechanism 8 is disposed on the housing 1 and configured to: in the first position, control the indicating mechanism 4 to indicate the deflection state of the cutting plane S0 relative to the reference plane in a first preset area; and in the second position, control the indicating mechanism 4 to indicate the deflection state of the cutting plane S0 relative to the reference plane in a second preset area.

In this embodiment, during use, the operator holds the first handle and the second handle respectively. Based on the required working posture, the first housing is switched between the first position and the second position relative to the second housing to achieve a suitable grip angle and operating space. During trimming, the cutting mechanism is driven to form the corresponding cutting plane, and the indicating mechanism presents the deflection state of the cutting plane relative to the reference plane in real time. When detecting that the first housing is in the first position, the control mechanism drives the indicating mechanism to display in the first preset area; and when the first housing switches to the second position, the control mechanism correspondingly switches the display area, causing the indicating mechanism to output a deflection indication in the second preset area. This allows the operator to read deflection information within an area primarily covered by his/her line of sight and make timely adjustments during operation, regardless of the grip position.

By establishing a correspondence between the display area of the indicating mechanism and the two positions of the first housing relative to the second housing, the presentation position of deflection information can be automatically adjusted when the tool body posture changes (e.g., grip posture switching, relative rotation of the housings). This ensures that the deflection indication always remains in an easily observable preset area, reducing misjudgments and delays caused by changes in viewing angle, obstructions, or deviation of the line of sight. Consequently, the visibility and consistency of deflection state prompts are enhanced, making it easier for the operator to quickly correct the posture of the cutting plane, reduce the risk of mis-cutting, improve operational safety and trimming efficiency, and enhance ergonomic adaptability across different working conditions.

In some embodiments, the first position may be a horizontal posture of the first housing 141 relative to the second housing 151, with a direction corresponding to the horizontal posture serving as a reference direction; the second position may be defined as a posture where the first housing 141 is deflected leftward relative to the second housing 151 (e.g., deflected by approximately 90° relative to the reference direction); and the third position may be defined as a posture where the first housing 141 is deflected rightward relative to the second housing 151 (e.g., deflected by approximately 90° relative to the reference direction), where left and right are defined with reference to the operator's normal grip state and facing the cutting mechanism 2.

In some embodiments of the present disclosure, the trimming tool further includes a detection mechanism 5. The detection mechanism 5 is accommodated inside the housing 1 and is configured to detect the deflection state of the cutting plane S0 relative to the reference plane and output a detection signal; the control mechanism 8 is electrically connected to the detection mechanism 5 and the indicating mechanism 4, and is configured to, when in the first or second position, control the indicating mechanism 4 to generate a first display signal based on a first detection signal detected by the detection mechanism 5, and control the indicating mechanism 4 to generate a second display signal based on a second detection signal detected by the detection mechanism 5.

For example, when the first housing 141 is in the first position (horizontal posture, reference direction 0°) relative to the second housing 151, the control mechanism 8 sets the display area of the indicating mechanism 4 as the first preset area: when the detection value meets a condition corresponding to a first threshold (e.g., an angle of deflection within 5°), a first display signal is displayed in the first preset area (e.g., illuminating one light bead); when the detection value meets a condition corresponding to a second threshold (e.g., an angle of deflection within 5° to 10°), a second display signal is displayed in the first preset area (e.g., illuminating two light beads); and when the detection value meets a condition corresponding to a third threshold (e.g., an angle of deflection within 10° to 15°), a third display signal is displayed in the first preset area (e.g., illuminating three light beads). When the first housing 141 is in the second position (deflected leftward) relative to the second housing 151, the control mechanism 8 switches the display area of the indicating mechanism 4 to the second preset area and displays the first, second, and third display signals respectively according to the same display rules as for the first preset area. Optionally, when the first housing 141 is in the third position (deflected rightward) relative to the second housing 151, the control mechanism 8 switches the display area of the indicating mechanism 4 to a third preset area and similarly displays first, second, and third signals respectively according to the aforementioned threshold segmentation rules. Thus, whether the first housing 141 is in the horizontal position or the left/right deflection position relative to the second housing 151, the operator can intuitively obtain deflection prompt information for the cutting plane S0 within the preset area corresponding to the current position.

Referring to FIGS. 1-3, a trimming tool includes a housing 1, a cutting mechanism 2, an indicating mechanism 4, and a control mechanism 8, where the housing 1 includes a first housing 141 provided with a first handle 12 and a second housing 151 provided with a second handle 13, the first housing 141 being movable relative to the second housing 151 between a first position and a second position; the cutting mechanism 2 is disposed on the housing 1 and has a cutting plane S0; the indicating mechanism 4 is disposed on the housing 1 and configured to indicate a deflection state of the cutting plane S0 relative to a reference plane; and the control mechanism 8 is disposed on the housing 1 and configured to control the indicating mechanism 4 to provide an indication based on the deflection state of the cutting plane S0 relative to the reference plane, regardless of whether the first housing 141 is in the first or second position relative to the second housing 151.

When the trimming tool is in use, the cutting mechanism 2 is driven to operate and form the cutting plane S0. A detection mechanism is arranged inside the housing 1 to detect the deflection state of the cutting plane S0 relative to the reference plane and output a detection signal corresponding to the deflection state. The control mechanism 8 receives the detection signal, generates a control command based on the deflection state represented by the detection signal, and then drives the indicating mechanism 4 to output display information corresponding to the current deflection state. This enables the operator to learn the deflection of the cutting plane S0 relative to the reference plane in real time and adjust the working posture accordingly.

It should be noted that, in this embodiment, the control of the indicating mechanism 4 by the control mechanism 8 is based on the deflection state of the cutting plane S0 relative to the reference plane, and does not depend on the relative position of the first housing 141 relative to the second housing 151. Consequently, regardless of whether the first housing 141 rotates relative to the second housing 151, and regardless of whether the first housing 141 is in the first or second position, the indicating mechanism 4 can normally and continuously display the deflection state. This reduces issues such as display interruption, misalignment, or inconsistent indication logic caused by relative rotation of the housing 1, thereby improving the reliability and usability of deflection prompts.

In this embodiment, when using the trimming tool, the operator holds the first handle and the second handle and moves the first housing relative to the second housing between the first position and the second position (e.g., switching grip angles or relative tool body posture) according to the required working posture. The cutting mechanism is driven to operate and form the corresponding cutting plane; the control mechanism acquires the deflection state of the cutting plane relative to the reference plane and, regardless of whether the first housing is in the first or second position relative to the second housing, controls the indicating mechanism to output corresponding indication information. This enables the operator to determine deflection in real time and adjust the trimming posture based on the indication information.

By making the control of the indicating mechanism by the control mechanism independent of the movement position of the first housing relative to the second housing (including whether rotation or posture switching occurs) and based solely on the deflection state of the cutting plane relative to the reference plane, issues such as prompt failure, display misalignment, or inconsistent indication logic caused by changes in the relative position of the tool body is capable of being reduced. This ensures that the indicating mechanism is able to normally and continuously display the deflection state regardless of the position of the first housing relative to the second housing. Consequently, the reliability and consistency of deflection prompts are enhanced, allowing the operator to promptly correct the cutting plane even during posture switching, reducing the risks of misjudgment and mis-cutting, improving trimming safety and operational efficiency, and enhancing ergonomic adaptability across different working conditions.

In conclusion, the present disclosure provides the trimming tool in one or more embodiments as described above. By providing the protective plate on the housing and arranging the indicating mechanism on the protective plate or on the front end area of the housing between the two handles (the first handle and the second handle), the indicating mechanism is positioned within the same forward field of view as the cutting plane. Combined with defining the straight line extending along the length direction of the cutting plane and parallel to the reference plane as the deflection axis, this unifies the reference system for cutting plane deflection from both structural and geometric definition perspectives. It enables the direction and degree of deflection of the cutting plane relative to the reference plane to be intuitively displayed directly in front of the operator, reducing the need for frequent lowering of the head or looking back, thereby improving the continuity and safety of trimming operations. By arranging the detection mechanism and explicitly defining the reference plane as the first reference plane and/or the second reference plane corresponding to the cutting plane being parallel to and perpendicular to the horizontal plane, the determination of cutting plane deflection is established on a unified spatial reference. The detection mechanism detects the deflection state of the cutting plane relative to the reference plane in real time and outputs the detection signal. The control mechanism drives the indicating mechanism to display based on the detection signal, converting posture determination that originally relied on visual estimation into objective sensing detection and visual prompts. This reduces trimming errors caused by differences in operational experience, lighting conditions, and changes in working conditions By arranging the front and rear distributed first handle and second handle on the housing, and defining geometric parameter ranges such as the first included angle between the display surface of the indicating mechanism and the cutting plane, the angle of inclination of the first handle relative to the reference plane, the second included angle between the preset plane and the cutting plane, the third included angle formed by the line connecting the first handle and the top end of the protective plate, and the lateral fourth included angle, while constraining the proportional relationship between the width of the second handle and the width of the indicating mechanism, a coordinated human-tool layout relationship is formed among the grip positions, indication positions, and the cutting area. The aforementioned angle and distance parameters are not arbitrarily selected but are optimized results determined through comprehensive consideration of grip comfort, field of view openness, protection requirements, and center-of-gravity stability. They ensure that the indication information is positioned in an easily observable and less obstructed location while maintaining stable tool control, thereby enhancing the ergonomic performance of the trimming process. By providing the first and second lead wires, the signal link between the detection mechanism, the control mechanism, and the light panels arranged in the middle or side areas of the protective plate is segmented. This not only ensures clear transmission paths and strong anti-interference capability for the deflection and display signals but also allows flexible adjustability in the installation position of the light panels, facilitating the reuse of the same detection and control modules across different tool models and protective plate structures, consequently reducing wiring complexity and manufacturing costs. By designing the indicating mechanism to include at least one set or multiple sets of light panels, arranging a plurality of light bead groups on the light panels, and combining variations in the illumination intensity, illumination position, and/or display color of the light bead groups to provide graded indication for different directions and angle ranges of deflection, more posture information is capable of being conveyed within a limited display area. This enables the operator to quickly and accurately identify the current deflection state of the cutting plane in a short time, allowing targeted adjustments to the trimming tool's posture, thereby improving the straightness and height consistency of trimming lines. By providing the rotatable connection between the first housing and the second housing, and arranging the sensing mechanism at the rotating shaft therebetween to acquire the relative rotation information of the first housing or the second housing and output the rotation signal, and by having the control mechanism drive the indicating mechanism arranged in the area corresponding to the first handle and/or the second handle for zonal display based on the rotation signal, a clear correspondence is established between the rotational posture of the first housing and the deflection state of the cutting plane about the deflection axis relative to the reference plane. Compared to solutions that only arrange detection elements at fixed positions on the housing, the present disclosure utilizes the operator's actual grip posture at the second handle as the reference for deflection determination. Without increasing the structural complexity of the cutting mechanism, dynamic monitoring and visual feedback of the cutting plane's posture are achieved, facilitating fine control of the cutting plane through slight adjustments to the rotational angle of the first housing while the operator maintains a stable grip on the second handle.

It should be understood that the present disclosure is not limited to the detailed structure and arrangement of components described herein. The present disclosure can have other embodiments and can be implemented and carried out in various ways. The aforementioned variations and modifications fall within the scope of the present disclosure. It should be understood that the present disclosure as disclosed and defined herein extends to all alternative combinations of two or more individual features mentioned and/or apparent from the text and/or accompanying drawings. All these different combinations constitute multiple alternative aspects of the present disclosure. The embodiments described herein illustrate the best mode currently known for implementing the present disclosure and will enable those skilled in the art to utilize the present disclosure.

What is claimed is:

1. A trimming tool, comprising:
a housing, provided with a protective plate thereon;
a cutting mechanism, disposed on the housing and having a cutting plane;
a driving mechanism, disposed on the housing and configured to drive the cutting mechanism to operate; and
an indicating mechanism, disposed on the protective plate and configured to indicate a deflection state of the cutting plane relative to a reference plane, wherein the deflection state is a state in which the cutting plane is deflected relative to the reference plane about a deflection axis, and the deflection axis is a straight line extending along a length direction of the cutting plane and parallel to the reference plane.

2. The trimming tool of claim 1, further comprising:
a detection mechanism, accommodated inside the housing and configured to detect the deflection state of the cutting plane relative to the reference plane and output a detection signal; and
a control mechanism, configured to control an operating state of the indicating mechanism based on the detection signal.

3. The trimming tool of claim 2, wherein the indicating mechanism comprises at least two sets of light panels; and
a predetermined angle is formed between projections of any two sets of the light panels on a plane of the protective plate.

4. The trimming tool of claim 2, wherein the indicating mechanism comprises at least two sets of light panels; and
projections of the at least two sets of light panels on a plane of the protective plate are parallel to each other.

5. The trimming tool of claim 2, wherein the indicating mechanism comprises at least two sets of light panels; and
among two adjacent sets of the light panels, an output terminal of one set of the light panels is connected to an input terminal of another set of the light panels in series.

6. The trimming tool of claim 2, wherein
the housing is provided with a first handle and a second handle; the first handle is disposed at one end of the housing proximate to the cutting mechanism and the protective plate; the second handle is disposed at the other end of the housing distal from the cutting mechanism and the protective plate; and the trimming tool is configured to be at least one of the following:
a first included angle is formed between a display surface of the indicating mechanism and the cutting plane, wherein the first included angle is greater than or equal to 20° and less than 90°;
the reference plane is perpendicular to the cutting plane, and an included angle of inclination is formed between the reference plane and a section extending along a length direction of the first handle, wherein the included angle of inclination is in a range of 0° to 15°;
a preset plane is formed between a bottom end of the indicating mechanism proximate to the housing and a top end of a gripping portion of the first handle, a second included angle is formed between the preset plane and the cutting plane, and the second included angle is between 0° and 90°;
a third included angle is formed between a plane where a line connecting a top end of the first handle and a top end of the protective plate lies and a horizontal plane where the top end of the first handle lies, wherein the third included angle is between 10° and 45°;
a fourth included angle is formed between a plane where a line connecting a vertex on a side portion of the first handle and a vertex on a side portion of the protective plate lies and the cutting plane, wherein the fourth included angle is between 0° and 35°; or
on a projection plane perpendicular to the cutting plane, a widest distance of a projection of the first handle is a first distance, and a widest distance of a projection of the indicating mechanism is a second distance; wherein the first distance ranges from 190 mm to 250 mm, the second distance ranges from 100 mm to 250 mm, and a ratio of the first distance to the second distance is between 1:1 and 1:2.5.

7. The trimming tool of claim 2, further comprising:
a first lead wire, having one end electrically connected to the detection mechanism, the first lead wire being configured to transmit a deflection signal acquired by the detection mechanism regarding the cutting plane relative to the reference plane; wherein the control mechanism is electrically connected to the other end of the first lead wire and is configured to output a display signal based on the deflection signal; and
a second lead wire, having one end electrically connected to the control mechanism and the other end electrically connected to an input terminal of any one set of light panels; wherein the second lead wire is configured to load the display signal onto the light panels.

8. The trimming tool of claim 5, wherein the light panels are provided with a plurality of light bead groups thereon; and
the operating state of the indicating mechanism comprises at least one of the following:
an illumination intensity of the light bead groups;
an illumination position of the light bead groups; or
a display color of the light bead groups.

9. The trimming tool of claim 2, further comprising:
a first damping unit, having one end connected to the driving mechanism and the other end located inside the housing, wherein a gap is reserved between the other end and an inner wall of the housing.

10. The trimming tool of claim 2, further comprising:
a second damping unit, disposed between the housing and the driving mechanism and configured to mitigate an impact of movement of the driving mechanism on the housing.

11. A trimming tool, comprising:
a housing, provided with a protective plate thereon;
a cutting mechanism, disposed on the housing and having a cutting plane;
a detection mechanism, disposed on the housing and configured to detect a deflection state of the cutting plane relative to a reference plane and output a detection signal;
a first lead wire, having one end electrically connected to the detection mechanism, the first lead wire being configured to transmit the detection signal acquired by the detection mechanism;
a control mechanism, disposed on the housing, electrically connected to the other end of the first lead wire, and configured to output a display signal based on the detection signal;
a driving mechanism, configured to drive the cutting mechanism to operate;
an indicating mechanism, disposed on the housing; and
a second lead wire, having one end electrically connected to the control mechanism and the other end connected to the indicating mechanism, the second lead wire being configured to transmit the display signal onto the indicating mechanism;
wherein the indicating mechanism is configured to indicate the deflection state of the cutting plane relative to the reference plane based on the display signal.

12. The trimming tool of claim 11, wherein the housing comprises a first housing provided with a first handle and a second housing provided with a second handle;
the first handle is closer to the cutting mechanism than the second handle; and
the protective plate is disposed at an end of the housing proximate to the cutting mechanism; the indicating mechanism is disposed on the protective plate, or the indicating mechanism is disposed on the housing between the first handle and the second handle.

13. The trimming tool of claim 11, wherein the housing comprises a first housing provided with a first handle and a second housing provided with a second handle, the first housing being rotatably connected to the second housing;
a sensing mechanism is disposed on the second housing and configured to acquire rotation information of the second housing or the first housing and output a rotation signal; and
the control mechanism is configured to control the indicating mechanism to provide an indication in a corresponding area based on the rotation signal, wherein the indication is provided according to the detection signal.

14. The trimming tool of claim 11, wherein
the indicating mechanism comprises at least one set of light panels;
an end of the second lead wire distal from the control mechanism is electrically connected to an input terminal of any one set of the light panels; and
the second lead wire is configured to load the display signal onto the light panels.

15. The trimming tool of claim 14, wherein
the light panels are provided with a plurality of light bead groups thereon; the indicating mechanism indicates an operating state of the light bead groups according to a signal loaded by a sensing mechanism; and the operating state of the light bead groups comprises at least one of the following:
an illumination intensity of the light bead groups;
an illumination position of the light bead groups; or
a change in a display color of the light bead groups.

16. A trimming tool, comprising:
a housing, comprising a first housing provided with a first handle and a second housing provided with a second handle, the first housing being movable relative to the second housing between a first position and a second position;
a cutting mechanism, disposed on the housing and having a cutting plane;
an indicating mechanism, disposed on the housing and configured to indicate a deflection state of the cutting plane relative to a reference plane; and
a control mechanism, disposed on the housing, wherein the control mechanism is configured to control the indicating mechanism to indicate the deflection state of the cutting plane relative to the reference plane in a first preset area when the first housing is in the first position relative to the second housing; and configured to control the indicating mechanism to indicate the deflection state of the cutting plane relative to the reference plane in a second preset area when the first housing is in the second position relative to the second housing.

17. The trimming tool of claim 16, further comprising:
a detection mechanism, accommodated inside the housing and configured to detect the deflection state of the cutting plane relative to the reference plane and output a detection signal;
wherein the control mechanism is further configured to control the indicating mechanism to generate a first display signal based on a first detection signal detected by the detection mechanism and a second display signal based on a second detection signal detected by the detection mechanism when the first housing is in the first or second position relative to the second housing.

18. The trimming tool of claim 16, wherein the trimming tool is configured to be at least one of the following:
the indicating mechanism has a display surface, a first included angle being formed between the display surface and the cutting plane, wherein the first included angle is greater than or equal to 20° and less than 90°;
an included angle of inclination is formed between the reference plane perpendicular to the cutting plane and a section extending along a length direction of the first handle, wherein the included angle of inclination is in a range of 0° to 15°;
a preset plane is formed between a bottom end of the indicating mechanism proximate to the housing and a top end of a gripping portion of the first handle, a second included angle is formed between the preset plane and the cutting plane, and the second included angle is between 0° and 90°;
a third included angle is formed between a plane where a line connecting a top end of the first handle and a top end of the protective plate lies and a horizontal plane where the top end of the first handle lies, wherein the third included angle is between 10° and 45°;
a fourth included angle is formed between a plane where a line connecting a vertex on a side portion of the first handle and a vertex on a side portion of the protective plate lies and the cutting plane, wherein the fourth included angle is between 0° and 35°; or
on a projection plane perpendicular to the cutting plane, a widest distance of a projection of the first handle is a first distance, and a widest distance of a projection of the indicating mechanism is a second distance, wherein the first distance ranges from 190 mm to 250 mm, the second distance ranges from 100 mm to 250 mm, and a ratio of the first distance to the second distance is between 1:1 and 1:2.5.

19. The trimming tool of claim 16, further comprising:
a first damping unit, having one end connected to a driving mechanism and the other end located inside the housing, wherein a gap is reserved between the first damping unit and an inner wall of the housing.

20. The trimming tool of claim 16, further comprising:
a second damping unit, disposed between the housing and a driving mechanism and configured to mitigate an impact of movement of the driving mechanism on the housing.
